(19) United States
(12) Patent Application Publication
(10) Pub. No.: US 2023/0365838 A1
(43) Pub. Date: Nov. 16, 2023

(54) PROCESS OF INCORPORATING GELLING AND PHASE SEPARATION INHIBITOR INTO A FILLED POLYURETHANE REACTIVE HOT MELT ADHESIVE

(71) Applicant: Henkel AG & Co. KGaA, Duesseldorf (DE)

(72) Inventors: Yingjie Li, Batavia, IL (US); Shuhui Qin, Palatine, IL (US)

(21) Appl. No.: 18/348,468

(22) Filed: Jul. 7, 2023

Related U.S. Application Data
(63) Continuation of application No. PCT/US2022/013972, filed on Jan. 27, 2022.
(60) Provisional application No. 63/142,735, filed on Jan. 28, 2021.
(60) Provisional application No. 63/260,741, filed on Aug. 31, 2021.

(51) Int. Cl. C09J 7/35; C09J 175/04; C09J 11/08; C09J 11/04; C09J 11/06

(52) U.S. Cl. CPC C09J 7/35; C09J 175/04; C09J 11/08; C09J 11/04; C09J 11/06; C09J 2301/50; C09J 2301/304

(57) ABSTRACT

Disclosed is a moisture reactive, polyurethane hot melt adhesive composition that is the reaction product of a first mixture comprising heat stabilizer and only one of polyester polyol or filler, wherein the first mixture can optionally comprise polyether polyol and/or thermoplastic polymer but does not comprise all of heat stabilizer and polyester polyol and filler; polyisocyanate; and a second mixture comprising the other of polyester polyol or filler not present in the first mixture; wherein the second mixture can optionally comprise polyether polyol and/or thermoplastic polymer. The moisture reactive hot melt adhesive can also comprise an additive selected from additional catalyst, additional filler, adhesion promoter, plasticizer, colorant, rheology modifier, flame retardant, UV pigment, nanofiber, defoamer, compatible tackifier, anti-oxidant, stabilizer, thixotrope and mixtures thereof.

### TECHNICAL FIELD

This disclosure relates generally to moisture reactive polyurethane hot melt adhesives and more particularly to moisture reactive polyurethane hot melt adhesives having low viscosity increase in the molten state and improved pot life.

### BACKGROUND OF THE INVENTION

This section provides background information which is not necessarily prior art to the inventive concepts associated with the present disclosure.

Hot melt adhesives are solid, semi-solid or viscous non-flowable mass at room temperature but, upon heating to temperatures of 60° C. or more, they melt to a liquid or fluid state having a viscosity suitable for application to a substrate. On cooling, the adhesive regains its solid form. One class of hot melt adhesives are thermoplastic hot melt adhesives. Thermoplastic hot melt adhesives are generally thermoplastic and can be repeatedly heated to a fluid state and cooled to a solid state. Thermoplastic hot melt adhesives cannot crosslink or cure; the hard phase(s) formed upon cooling the thermoplastic hot melt adhesive imparts all of the cohesion strength, toughness, creep and heat resistance to the final adhesive. Naturally, the thermoplastic nature limits the upper temperature at which such adhesives can be used.

Another class of hot melt adhesives are curable or reactive hot melt adhesives. Reactive hot melt adhesives start out as thermoplastic materials that can be repeatedly heated to temperatures of 60° C. or more to form a molten state and cooled to a solid state. However, when exposed to appropriate conditions, for example exposure to moisture in the air or on a substrate, the reactive hot melt adhesive crosslinks and cures to an irreversible solid form. Reactive hot melt adhesives include moisture reactive polyurethane adhesives, moisture reactive organosilane adhesives; moisture reactive polysiloxane adhesives and moisture reactive silane polyolefin adhesives. The polyurethane hot melt adhesives comprise isocyanate terminated polyurethane prepolymers. Isocyanate terminated polyurethane prepolymers are conventionally obtained by reacting polyols with a molar excess of polyisocyanates. Isocyanate terminated polyurethane prepolymers cure by reaction of the terminal isocyanate groups in the prepolymer with moisture from the atmosphere or moisture on the substrates. This reaction results in a crosslinked material polymerized primarily through urea groups and urethane groups.

Reactive hot melt adhesives must be maintained at molten temperatures during use. However, even when kept under generally anhydrous conditions reactive hot melt adhesives will increase in viscosity while in a molten state. Eventually the adhesive viscosity increase requires shutdown of the hot melt adhesive application equipment and cleaning to remove the high viscosity hot melt adhesive. The time until the molten adhesive reaches an unusable viscosity is called the pot life. In very undesirable cases the molten reactive hot melt adhesive can gel or phase separate in application equipment while in use. Either situation requires equipment shutdown, disassembly, cleaning and possibly replacement of parts that cannot be cleaned of the gelled hot melt adhesive. Naturally, excessive viscosity increases, gelling or phase separation of the reactive hot melt adhesive is considered undesirable and commercially unacceptable.

Fillers are desirable to improve properties of a moisture reactive hot melt adhesive and are commonly included in such compositions. However, adding large amounts of fillers to moisture reactive hot melt adhesives can substantially increase the rate of viscosity rise of that composition in the molten state and shorten the useful pot life of those adhesives. In worst cases adding large amounts of filler can cause the moisture reactive adhesives to gel or phase separate during use. It would be desirable to provide a moisture reactive hot melt adhesive that includes high levels of non-fossil fuel based, sustainable, renewable additives while having a low viscosity increase in the molten state.

### SUMMARY OF THE DISCLOSURE

This section provides a general summary of the disclosure and is not a comprehensive disclosure of its full scope or all features, aspects or objectives.

A first embodiment is a moisture reactive hot melt adhesive polyurethane composition that includes the reaction product of:
a first mixture comprising heat stabilizer and only one of polyester polyol or filler, wherein the first mixture can optionally comprise polyether polyol and/or thermoplastic polymer but does not comprise all of heat stabilizer and polyester polyol and filler;
a second mixture comprising the other of polyester polyol or filler not present in the first mixture; wherein the second mixture can optionally comprise polyether polyol and/or thermoplastic polymer; and
a polyisocyanate.

Preferably, the reaction product in any embodiment is not based on moisture curable silane alkoxy terminated polymers. In some variations the composition is free of silane alkoxy and/or silicon atom containing compounds. In some variations the isocyanate containing reaction product molecules are free of silane alkoxy moieties and/or silicon atoms.

A second embodiment is the moisture reactive hot melt adhesive polyurethane composition of embodiment 1 wherein the second mixture is mixed with the first mixture and the polyisocyanate is reacted with the combined first mixture and second mixture.

A third embodiment is the moisture reactive hot melt adhesive polyurethane composition of any one of the above embodiments wherein the first mixture has been mixed for at least 35 minutes; preferably at least 45 minutes and more preferably at least one hour before mixing with the second mixture or the polyisocyanate.

A fourth embodiment is the moisture reactive hot melt adhesive polyurethane composition of any one of the above embodiments wherein the polyester polyol is the reaction product of a diol having 2 to 8 carbon atoms and a diacid having 2 to 8 carbon atoms.

A fifth embodiment is the moisture reactive hot melt adhesive polyurethane composition of any one of the above embodiments wherein the polyester polyol has a structure of Formula 1 or of Formula 2; wherein Formula 1 is:

H—[O(CH₂)ₘOOC(CH₂)ₙCO]ₖ—O(CH₂)ₚ—OH;
m and n being an independently selected even integer; m+n=6 to 10, preferably =8; m and n are independently selected from 2, 4, 6 or 8, preferably 2, 4 or 6; p is equal to m; k is an integer from 9 to 55; and the polyol of Formula I has a number average molecular weight of around 2,000 to 11.000; and Formula 2 is:

HO—[(CH₂)₅COO]ₚ—R₁—[OOC(CH₂)₅]_{q}—OH;
R₁ is an initiator; p is an integer from 0 to 96; q is an integer from 0 to 96; p+q=16 to 96; and the polyol has a number average molecular weight of about 2,000 to about 11,000.

A sixth embodiment is the moisture reactive hot melt adhesive polyurethane composition of any one of the above embodiments comprising one or more of MA-SCA acid, catalyst, organosilane and additive.

A seventh embodiment is the moisture reactive hot melt adhesive of any one of the above embodiments wherein the filler is CaCO₃ and/or comprising about 10 to about 50 wt. % filler, based on the total adhesive weight.

An eighth embodiment is the moisture reactive hot melt adhesive of any one of the above embodiments wherein the thermoplastic polymer is an acrylic polymer.

A ninth embodiment is the moisture reactive hot melt adhesive of any one of the above embodiments wherein the thermoplastic polymer is an acrylic polymer and the first mixture comprises the filler and the acrylic polymer.

A tenth embodiment is the moisture reactive hot melt adhesive of any one of the above embodiments wherein the first mixture, the second mixture or both the first mixture and the second mixture comprise the polyether polyol and the polyether polyol is polypropylene glycol.

An eleventh embodiment is the moisture reactive hot melt adhesive of any one of the above embodiments wherein the reaction product is an isocyanate functional polyurethane prepolymer.

A twelfth embodiment is the moisture reactive hot melt adhesive composition as recited in any one of the above embodiments, further comprising an additive selected from additional catalyst, additional filler, adhesion promoter, plasticizer, colorant, rheology modifier, flame retardant, UV pigment, nanofiber, defoamer, compatible tackifier, anti-oxidant, stabilizer, thixotrope and mixtures thereof.

A thirteenth embodiment is the moisture reactive hot melt adhesive composition as recited in any one of the above embodiments further comprising 2,2′-dimorpholinodiethylether (DMDEE).

A fourteenth embodiment is an article of manufacture comprising the moisture reactive hot melt adhesive composition according to any one of the above embodiments.

A fifteenth embodiment is a method of bonding two substrates together comprising applying the hot melt adhesive according any one of the above embodiments in molten form to a first substrate and then bringing a second substrate into contact with the adhesive on the first substrate and allowing the adhesive to cool and cure to an irreversible solid form.

A sixteenth embodiment is a cured reaction product of the hot melt adhesive composition according to any one of the above embodiments.

A seventeenth embodiment is a method of making a moisture reactive hot melt adhesive having improved heat stability, comprising:
preparing a first part comprising heat stabilizer and only one of polyester polyol or filler, wherein the first mixture can optionally comprise a polyether polyol and/or a thermoplastic polymer but does not comprise all of the heat stabilizer, the polyester polyol and the filler;
mixing the first mixture for a time sufficient to pretreat the polyester polyol or the filler;
providing a second part comprising the other of the polyester polyol or the filler not present in the first part;
providing a polyisocyanate; and
reacting the first part, the second part and the polyisocyanate components to form a moisture reactive, polyurethane hot melt adhesive.

In a variation of the seventeenth embodiment the second part is mixed with the first part to form a mixture and the polyisocyanate is reacted with the mixture.

In a variation of the seventeenth embodiment the polyisocyanate is reacted with the first part to form a mixture and the second part is reacted with the mixture.

In a variation of the seventeenth embodiment the polyisocyanate is reacted with the second part to form a mixture and the first part is reacted with the mixture.

An eighteenth embodiment is use of a heat stabilizer to extend the heat stability of a molten moisture reactive hot melt adhesive composition.

The disclosed compounds include any and all isomers and stereoisomers. In general, unless otherwise explicitly stated the disclosed materials and processes may be alternately formulated to comprise, consist of, or consist essentially of, any appropriate components, moieties or steps herein disclosed. The disclosed materials and processes may additionally, or alternatively, be formulated so as to be devoid, or substantially free, of any components, materials, ingredients, adjuvants, moieties, species and steps used in the prior art compositions or that are otherwise not necessary to the achievement of the function and/or objective of the present disclosure.

These and other features and advantages of this disclosure will become more apparent to those skilled in the art from the detailed description of a preferred embodiment. The drawings that accompany the detailed description are described below.

### DETAILED DESCRIPTION OF A PREFERRED EMBODIMENT

The singular forms “a”, “an” and “the” include plural referents unless the context clearly dictates otherwise.

“About” or “approximately” as used herein in connection with a numerical value refer to the numerical value ±10%, preferably ±5% and more preferably ±1% or less.

“Alkyl” refers to a monovalent group that a radical of an alkane and includes straight-chain, branched and cyclic organic groups. Examples of alkyl groups include but are not limited to: methyl; ethyl; propyl; isopropyl; n-butyl; isobutyl; sec-butyl; tert-butyl; n-pentyl; n-hexyl; cyclohexyl; n-heptyl; and 2-ethylhexyl. Alkyl groups may be unsubstituted or may be substituted in any possible position. Exemplary substituent groups include, for example, one or more substituents such as halo, nitro, carbonyl, alkoxy, cyano, amido, amino, sulfonyl, sulfinyl, sulfanyl, sulfoxy, urea, thiourea, sulfamoyl, sulfamide and hydroxy.

“Alkoxy” refers to a monovalent group having the formula —O-alkyl. Alkoxy groups may be unsubstituted or may be substituted in any possible position. Exemplary substituent groups include, for example, one or more substituents such as halo, nitro, cyano, amido, amino, sulfonyl, sulfinyl, sulfanyl, sulfoxy, urea, thiourea, sulfamoyl, sulfamide and hydroxy.

“Aryl”, used alone or as part of a larger moiety—as in “aralkyl group”, refers to optionally substituted, monocyclic, bicyclic and tricyclic ring systems in which the monocyclic ring system is aromatic or at least one of the rings in a bicyclic or tricyclic ring system is aromatic. The bicyclic and tricyclic ring systems include benzofused 2-3 membered carbocyclic rings. Exemplary aryl groups include: phenyl; indenyl; naphthalenyl, tetrahydronaphthyl, tetrahydroindenyl; tetrahydroanthracenyl; and anthracenyl. A preference for phenyl groups may be noted. Aryl groups may be unsubstituted or may be substituted in any possible position. Exemplary substituent groups include, for example, one or more substituents such as hydrocarbyl, alkoxy, halo, nitro, cyano, amido, amino, sulfonyl, sulfinyl, sulfanyl, sulfoxy, urea, thiourea, sulfamoyl, sulfamide and hydroxy.

“Aralkyl” refers to an alkyl group that is substituted with an aryl group. An example of an aralkyl group is benzyl.

Unless otherwise defined “%” refers to weight percent, preferably wt. % based on the entire composition.

At least one, as used herein, means 1 or more, i.e., 1, 2, 3, 4, 5, 6, 7, 8, 9, or more. With reference to an ingredient, the indication refers to the type of ingredient and not to the absolute number of molecules. “At least one polymer” thus means, for example, at least one type of polymer, i.e., that one type of polymer or a mixture of several different polymers may be used.

The terms “comprising”, “comprises” and “comprised of” as used herein are synonymous with “including”, “includes”, “containing” or “contains”, and are inclusive or open-ended and do not exclude additional, non-recited members, elements or method steps.

The term “essentially free” is intended to mean herein that the applicable group, compound, mixture or component constitutes less than 1 wt. %; typically, less than 0.7 wt. %, preferably less than 0.5 wt. %, more preferably less than 0.1 wt. %, and ideally no more than a trace amount based on the weight of the defined composition.

“Free of”, as used in this context, means that the amount of the corresponding substance in the reaction mixture is less than 0.05 wt. %, preferably less than 0.01 wt. %, more preferably less than 0.001 wt. %, based on the total weight of the reaction mixture.

“Halogen,” “halo” or “hal” when used alone or as part of another group mean chlorine, fluorine, bromine or iodine.

“Hydrocarbyl” refers to a group containing carbon and hydrogen atoms. The hydrocarbyl can be linear, branched, or cyclic group. The hydrocarbyl can be alkyl, alkenyl, alkynyl or aryl. Hydrocarbyl groups may be unsubstituted or may be substituted in any possible position. Exemplary substituent groups include, for example, one or more substituents such as alkoxy, halo, nitro, cyano, amido, amino, sulfonyl, sulfinyl, sulfanyl, sulfoxy, urea, thiourea, sulfamoyl, sulfamide and hydroxy.

When amounts, concentrations, dimensions and other parameters are expressed in the form of a range, a preferable range, an upper limit value, a lower limit value or preferable upper and limit values, it should be understood that any ranges obtainable by combining any upper limit or preferable value with any lower limit or preferable value are also specifically disclosed, irrespective of whether the obtained ranges are clearly mentioned in the context.

“Preferred” and “preferably” are used frequently herein to refer to embodiments of the disclosure that may afford particular benefits, under certain circumstances. However, the recitation of one or more preferable or preferred embodiments does not imply that other embodiments are not useful and is not intended to exclude those other embodiments from the scope of the disclosure.

Unless specifically noted, throughout the present specification and claims the term molecular weight when referring to a polymer refers to the polymer's number average molecular weight (Mn). The number average molecular weight Mₙ can be calculated based on end group analysis (OH numbers according to DIN EN ISO 4629, free NCO content according to EN ISO 11909) or can be determined by gel permeation chromatography according to DIN 55672 with THF as the eluent. If not stated otherwise, all given molecular weights are those determined by gel permeation chromatography.

“Room temperature” is 23° C. plus or minus 10° C.

An adhesive's “open time” refers to the time during which an adhesive can bond to a material.

Moisture reactive polyurethane hot melt adhesives find widespread use in panel lamination procedures. They provide good adhesion to a variety of materials and good structural bonding. Their lack of a need for a solvent, rapid green strength development, and good resistance to heat, cold and a variety of chemicals make them ideal choices for use in the building industries. In particular, they find use in door lamination and recreation vehicle panel lamination. In these applications the hot melt adhesive will be held in the molten state at high temperatures for long periods of time during use.

The present disclosure is directed toward providing reactive polyurethane hot melt adhesives that incorporate high levels of sustainable, renewable, non-fossil fuel components such as fillers while maintaining their viscosity in the molten state. The reactive polyurethane hot melt adhesives typically have melting points above 60° C., preferably above 80° C. and more preferably above 100° C.

The disclosed hot melt adhesives are a reaction product of a mixture comprising: an organic polyisocyanate, a polyol, a heat stabilizer, filler and thermoplastic polymer. The mixture or the adhesive can optionally comprise one or more additional components such as MA-SCA acid, catalyst, organosilane and other additives. Preferably the hot melt adhesive is free of organic solvents, water, photoinitiators and thermal initiators.

Organic polyisocyanates that can be used include alkylene diisocyanates, cycloalkylene diisocyanates, aromatic diisocyanates and aliphatic-aromatic diisocyanates. Examples of isocyanates for use in the present disclosure include, by way of example and not limitation: methylenebisphenyldiisocyanate (MDI), isophorone diisocyanate (IPDI), hydrogenated methylenebisphenyldiisocyanate (HMDI), toluene diisocyanate (TDI), ethylene diisocyanate, ethylidene diisocyanate, propylene diisocyanate, butylene diisocyanate, trimethylene diisocyanate, hexamethylene diisocyanate, cyclopentylene-1,3-diisocyanate, cyclo-hexylene-1,4-diisocyanate, cyclohexylene-1,2-diisocyanate, 4,4′-diphenylmethane diisocyanate, 2,2-diphenylpropane-4,4′-diisocyanate, xylylene diisocyanate, 1,4-naphthylene diisocyanate, 1,5-naphthylene diisocyanate, m-phenylene diisocyanate, p-phenylene diisocyanate, diphenyl-4,4′-diisocyanate, azobenzene-4,4′-diisocyanate, diphenylsulphone-4,4′-diisocyanate, 2,4-tolylene diisocyanate, dichlorohexa-methylene diisocyanate, furfurylidene diisocyanate, 1-chlorobenzene-2,4-diisocyanate, 4,4′,4″-triisocyanatotriphenylmethane, 1,3,5-triisocyanato-benzene, 2,4,6-triisocyanato-toluene, 4,4′-dimethyldiphenyl-methane-2,2′,5,5-tetratetraisocyanate, and the like. While such compounds are commercially available, methods for synthesizing such compounds are well known in the art. Preferred isocyanate-containing compounds are isomers of methylenebisphenyldiisocyanate (MDI), isophorone diisocyanate (IPDI), hydrogenated MDI (HMDI) and toluene diisocyanate (TDI).

Polyols that can be used include those polyols typically used for the production of polyurethanes, including, without limitation, polyether polyols, polyester polyols, polybutadiene polyols, polycarbonate polyols, polyacetal polyols, polyamide polyols, polyesteramide polyols, polyalkylene polyether polyols, polythioether polyols and mixtures thereof; preferably polyether polyols, polyester polyols, polycarbonate polyols and mixtures thereof; and more preferably polyester polyols or combinations of polyester polyols and polyether polyols.

Useful polyester polyols include those that are obtainable by reacting, in a polycondensation reaction, dicarboxylic acids with polyols. The dicarboxylic acids may be aliphatic, cycloaliphatic or aromatic and/or their derivatives such as anhydrides, esters or acid chlorides. Specific examples of these are succinic acid, glutaric acid, adipic acid, pimelic acid, suberic acid, azelaic acid, sebacic acid, dodecandioic acid, phthalic acid, terephthalic acid, isophthalic acid, trimellitic acid, phthalic acid anhydride, tetrahydrophthalic acid anhydride, glutaric acid anhydride, maleic acid, maleic acid anhydride, fumaric acid, dimeric fatty acid, dodecane dioic acid and dimethyl terephthalate. Examples of suitable polyols are monoethylene glycol, 1,2-propanediol, 1,3-propanediol, 1,4-butanediol, 3-methylpentane-1,5-diol, neopentyl glycol (2,2-dimethyl-1,3-propanediol), 1,6-hexanediol, 1,8-otaneglycol cyclohexanedimethanol, 2-methylpropane-1,3-diol, diethyleneglycol, triethyleneglycol, tetraethyleneglycol, polyethyleneglycol, dipropyleneglycol, tripropyleneglycol, tetrapropyleneglycol, polypropyleneglycol, dibutyleneglycol, tributyleneglycol, tetrabutyleneglycol and polybutyleneglycol. Alternatively, they may be obtained by ring-opening polymerization of cyclic esters, preferably caprolactone. Polyester polyols are commercially available, for example Piothane polyols available from Panolam Industries International and Dynacoll polyols available from Evonik. Other suppliers include Stepan, COIM and Lanxess. In some embodiments polyhexanediol adipate polyols are preferred.

In one embodiment the polyester polyols used in the adhesive comprise polyester diol polymers that have the structure of Formula 1 or Formula 2, either alone or in combination with one or more additional polyols. The polyester diol polymers of Formula 1 or Formula 2 preferably have a number average molecular weight of about 2,000 to about 11,000 Daltons, more preferably from about 2,000 to about 10,000, and further preferably from about 2,500 to about 6,000. For the polyester diol polymers, according to the present disclosure the relationship between the number average molecular weight (Mn), functionality of the polyol (f) and the hydroxyl number of the polyol (OH #) can be expressed by the following equation Mn=(f)*(56100/OH #). Formula 1 is:

H—[O(CH₂)ₘOOC(CH₂)ₙCO]ₖ—O(CH₂)ₚ—OH;

m and n being an independently selected from 2, 4, 6 or 8, preferably 2, 4 or 6; m+n=6 to 10, preferably =8; p is equal to m; k is an integer from about 9 to about 55; and the polyol of Formula I has a number average molecular weight of around 2,000 to 11.000.

Formula 2, the polycaprolactone, is:

HO—[(CH₂)₅COO]ₚ—R₁—[OOC(CH₂)₅]_{q}—OH;

R₁ is an initiator such as 1,4′-butanediaol, 1,6′-hexanediol, or ethylene glycol; p is an integer from 0 to 96; q is an integer from 0 to 96; p+q=16 to 96; and the polyol has a number average molecular weight of around 2,000 to 11,000.

Useful polyether polyols that can be used include linear and branched homo polyethers having hydroxyl groups. Examples of the polyether polyol may include a polyoxyalkylene polyol such as polyethylene glycol, polypropylene glycol, polybutylene glycol and the like. Further, a copolymer of the polyoxyalkylene polyols may also be employed. Particularly preferable copolymers of the polyoxyalkylene polyols may include an adduct of at least one compound selected from the group ethylene glycol, propylene glycol, diethylene glycol, dipropylene glycol, triethylene glycol, 2-ethylhexanediol-1,3, glycerin, 1,2,6-hexane triol, trimethylol propane, trimethylol ethane, tris(hydroxyphenyl)propane, triethanolamine, triisopropanolamine, ethylenediamine and ethanolamine. Preferably the polyether polyol comprises polypropylene glycol. Preferably the polyether polyol has a number average molecular weight of from 1,500 to 6,000 with a more preferred range of 2,000 to 4,000 Daltons. The polyether polyol may comprise a mixture of different polyether polyols.

Useful polycarbonate polyols can be obtained by reaction of carbon acid derivatives, e.g. diphenyl carbonate, dimethyl carbonate or phosgene with diols. Suitable examples of such diols include ethylene glycol, 1,2- and 1,3-propanediol, 1,3- and 1,4-butanediol, 1,6-hexanediol, 1,8-octanediol, neopentyl glycol, 1,4-bishydroxymethyl cyclohexane, 2-methyl-1,3-pro-panediol, 2,2,4-trimethyl pentanediol-1,3, dipropylene glycol, polypropylene glycols, dibutylene glycol, polybutylene glycols, bisphenol A, bisphenol F, tetrabromobisphenol A as well as lactone-modified diols. In some embodiments the diol component preferably contains 40 to 100 wt. % hexanediol, preferably 1,6-hexanediol and/or hexanediol derivatives. More preferably the diol component includes examples that in addition to terminal OH groups display ether or ester groups. The polycarbonate polyols should be substantially linear. However, they can optionally be slightly branched by the incorporation of polyfunctional components, in particular low-molecular polyols. Suitable examples include glycerol, trimethylol propane, hexanetriol-1,2,6, butanetriol-1,2,4, trimethylol propane, pentaerythritol, quinitol, mannitol, and sorbitol, methyl glycoside, 1,3,4,6-dianhydrohexites.

Useful polyols further comprise polyols that are hydroxy-functionalized polymers, for example hydroxy-functionalized siloxanes as well as polyols that comprise additional functional groups, such as vinyl or amino groups.

The mixture includes a heat stabilizer component that decreases viscosity increase of the moisture reactive hot melt adhesive in the molten state. Useful heat stabilizers include carbodiimide compounds and sulfonyl isocyanate compounds. Carbodiimides compounds are molecules that contain one —N═C═N— group or multiple —N═C═N— groups. Carbodiimides can be monomeric or polymeric. One class of monomeric carbodiimide is Ra—N═C═N—Rb where Ra and Rb are two separate organic groups. Polymeric carbodiimides have multiple N═C═N moieties joined by independently selected hydrocarbyl moieties, in one example, the polymeric carbodiimide can be represented by (R—N═C═N—R)n where n is 2 or more and each R is an organic group that can be the same or different.

A commercially available monomeric carbodiimide is 2,2′,6,6′-tetraisopropyldiphenyl carbodiimide available from Lanxess. Some commercially available polymeric carbodiimides include Stabaxol P, Stabaxol P200 and Stabaxol P400, all available from Lanxess.

Sulfonyl isocyanate compounds comprise one or more —S(O)₂—NCO moieties within the formula. In one embodiment sulfonyl isocyanate compounds have a general R—S(O)₂—NCO formula where R can be a halogen atom, a hydrocarbyl group, an alkoxy group, or an isocyanato group. In some embodiments R is selected from a C₁-C₁₂ alkyl group, a substituted C₁-C₁₂ alkyl group, an aryl group, or a substituted aryl group. Commercially available sulfonyl isocyanate compounds include 4-methylbenzenesulfonyl isocyanate (tosyl isocyanate or p-toluenesulfonyl isocyanate) and chlorosulfonyl isocyanate.

The mixture comprises one or more fillers. Some fillers include, for example, lime, precipitated and/or pyrogenic silica, zeolites, bentonites, carbonates such as calcium carbonate and magnesium carbonate, diatomite, alumina, clay, talc, metal oxide such as titanium oxide, iron oxide and zinc oxide, sand, quartz, flint, mica, glass powder, and other ground mineral substances. Organic fillers may also be useful, such as carbon black, graphite, wood fibers, wood flour, sawdust, cellulose, cotton, pulp, cotton, wood chips, chopped straw, chaff, ground walnut shells, and chopped fibers. Other examples of suitable fillers can be found in Handbook of Fillers, by George Wypych 3^{rd} Edition 2009 and Handbook of Fillers and Reinforcements for Plastics, by Harry Katz and John Milewski 1978. A combination of different fillers can also be used.

Inorganic fillers such as calcium carbonate, kaolin and dolomite are preferred. Calcium carbonate is more preferred as it is a non-fossil fuel based, sustainable, renewable material.

Polyurethane adhesives and sealants used at room temperature can incorporate some small amount of inorganic filler with no problem. However, adding a large amount of filler, for example 10 to 20 wt. % or more, to a hot melt adhesive is known to lead to adhesives that have short open times; quick viscosity increase of the adhesive in the molten state; and even phase separation and/or gelling of the adhesive during use. Adding a heat stabilizer to a highly filled hot melt adhesive surprisingly lessens the filler induced viscosity rise in the molten state and can avoid filler induced gelling and phase separation.

The mixture includes thermoplastic polymers. Preferred thermoplastic polymers include acrylic polymers. Acrylic polymers can be acrylic homopolymers or acrylic copolymers. Acrylic copolymers can be the reaction product of acrylate monomers, methacrylate monomers and mixtures thereof. Acrylic polymers can also be the reaction product of a non-acrylic monomer along with acrylate monomers, methacrylate monomers and mixtures thereof. In some embodiments acrylic polymers prepared from at least one of methyl methacrylate monomers and n-butyl methacrylic monomers are preferred. Examples of some preferred acrylic copolymers include Elvacite® 2013, which is a methyl methacrylate and n-butyl methacrylate copolymer having a weight average molecular weight of 34,000; Elvacite® 2016, which is a methyl methacrylate and n-butyl methacrylate copolymer having a weight average molecular weight of 60,000; and Elvacite® 4014 which is copolymer of methyl methacrylate, n-butyl methacrylate and hydroxyethyl methacrylate and has a weight average molecular weight of 60,000. The Elvacite® polymers are available from Lucite International. Other examples of acrylic polymers can be found in U.S. Pat. Nos. 6,465,104 and 5,021,507 herein incorporated by reference. The acrylic polymer may include active hydrogens or not. In some embodiments the acrylic polymer has a weight average molecular weight of from 20,000 to 80,000, more preferably from 30,000 to 70,000. In some embodiments the acrylic polymer has an OH number of less than 8, more preferably less than 5. In some embodiments the acrylic polymer has a glass transition temperature Tg of from about 35 to about 85° C., preferably from 45 to 75° C.

The adhesive can optionally include an MA-SCA acid. An MA-SCA acid is a subset of multibasic acids having acidic groups connected eventually to a single central atom. Examples of MA-SCA acids include sulfuric acid, phosphonic acid, phosphoric acid and diphosphoric acid (pyrophosphoric acid). Examples of other acids which are not MA-SCA acids under this disclosure and which should not be used in the disclosed compositions include hydrochloric acid, nitric acid, phosphinic acid, p-toluenesulfonic acid, ethanesulfonic acid, methanesulfonic acid, trifluoromethane sulfonic acid, acetic acid, propionic acid, fumaric acid, maleic acid, ethanedioic acid and adipic acid. Preferably, the composition includes an MA-SCA acid.

The composition can optionally include a catalyst. The catalyst can be any moisture curing catalyst for isocyanates, for example 2,2′-dimorpholinodiethylether, triethylenediamine, dibutyltin dilaurate and stannous octoate. While metal based catalysts can work, they are preferably not used. Organic catalysts such as the tertiary amine catalyst 2,2′-dimorpholinodiethylether (DMDEE) are preferred.

Organosilanes can optionally be used. Organosilanes that can be used include amino-silane such as a secondary amino-silane. One attractive silane includes at least two silyl groups, with three methoxy groups bond to each of the silanes hindered secondary amino group or any combination thereof. An example of one such commercially available amino-silane is bis-(trimethoxysilylpropyl)-amine, such as Silquest A-1170. Other examples of useful organosilanes include silanes having a hydroxy functionality, a mercapto functionality, or both, such as 3-aminopropyltrimethoxysilane, 3-aminopropyltriethoxysilane, 3-aminopropyltrismethoxy-ethoxyethoxysilane, 3-aminopropy 1-methy 1-diethoxysilane, N-methyl-3-aminopropyltrimethoxysilane, N-butyl-3-aminopropyltrimethoxysilane, 3-mercaptopropyltrimethoxysilane, 3-mercaptopropyltriethoxysilane, 3-mercaptopropyl-methyldimethoxysilane, (N-cyclohexylaminomethyl)methyldiethoxysilane, (N-cyclohexylaminomethyl) triethoxysilane, (N-phenylaminom-ethyl)methyldimethoxysilane, (N-phenylaminomethyl) tri-methoxysilane, N-ethyl-aminoisobutyltrimethoxysilane, 4-amino-3,3-dimethylbutyltrimethoxysilane, N-(n-butyl)-3-aminopropyltriethoxysilane,N-(n-butyl)-3-aminopropylalkoxydiethoxy-silane, bis(3-triethoxysilylpropyl)amine and any combination thereof.

Organosilanes are commercially available from many sources, for example Momentive Performance Materials (Silquest) and Evonik (Dynasylan). Some useful examples include Silquest Alink 15 (N-ethyl-3-trimethoxysilyl-2-methylpropanamine), Silquest Alink 35 (Gamma-isocyanatopropyltrimethoxysilane), Silquest A174NT (Gamma-methacryloxypropyltrimethoxysilane), Silquest A187 (Gamma-glycidoxypropyltrimethoxysilane), Silquest A189 (Gamma-mercaptopropyltrimethoxysilane), Silquest A 597 (Tris(3-(trimethoxysilyl)propyl)isocyanurate), Silquest A1110 (Gamma-aminopropyltrimethoxysilane), Silquest A1170 (Bis(trimethoxysilylpropyl)amine), Dynasylan 1189 (N-butyl-3-aminopropyltrimethoxysilane), Silquest A1289 (bis-(triethoxysilylpropyletrasulfide), and Silquest Y9669 (N-phenyl-gamma-aminopropyltrimethoxysilane).

The adhesive formulation can optionally include one or more of a variety of known hot melt adhesive additives such as, for example, additional catalyst, additional filler, plasticizer, colorant, rheology modifier, flame retardant, UV pigment, nanofiber, defoamer, compatible tackifier, anti-oxidant, stabilizer, thixotrope, and the like. Conventional additives that are compatible with a composition according to this invention may simply be determined by combining a potential additive with the composition and determining if they are compatible. An additive is compatible if it is homogenous within the product at room temperature and at the use temperature.

Solvent can optionally be present as an additive. Useful solvents include organic solvents. Aqueous solvents will initiate curing so the adhesive formulation is preferably essentially free of any water. Preferably, the adhesive composition is essentially free from any solvents or water in any stage of the formulation.

In one embodiment the hot melt adhesive comprises a reaction product of a mixture comprising:

| | | narrower | preferred |
|---|---|---|---|
| | range | range | range |
| | (wt. %) | (wt. %) | (wt. %) |
| polyisocyanate | 5-40 | 5-30 | 5-25 |
| polyether polyol | 0-40 | 10-35 | 15-35 |
| polyester polyol | 10-50 | 10-40 | 10-30 |
| inorganic filler | 1-70 | 10-50 | 15-40 |
| thermoplastic polymer | 1-50 | 10-40 | 15-35 |
| catalyst | 0-1 | 0.01-1 | 0.02-0.5 |
| heat stabilizer | 0.00005-3 | 0.0001-2 | 0.05-1.5 |
| organosilane | 0-10 | 0-5 | 0-2.5 |
| MA-SCA acid | 0.001-5.0 | 0.01-2.5 | 0.05-1.0 |
| additives | 0-50 | 0-35 | 0-25 |

The disclosed hot melt adhesive is a solid at room temperature and is stable during room temperature storage as long as moisture is excluded. The disclosed hot melt adhesives are heated to a molten form and applied in molten form in a variety of manners including by spraying, roller coating, extruding and as a bead. The disclosed adhesive can be used for bonding a variety of materials including metal, wood, plastic, glass and textile.

Hot melt adhesives are heated to molten form and maintained at high temperatures such as 121° C. or higher during use. In the absence of moisture, the molten hot melt adhesive must maintain an acceptable viscosity increase for 24 hours or more to avoid equipment shutdown. In some embodiments the disclosed hot melt adhesives have a viscosity increase (heat stability) of 1000% or less, more typically 500% or less, preferably 300% or less and more preferably 100% or less during use. Any gelling or separation into phases while the hot melt adhesive is in molten form is also objectionable and considered a failure of heat stability.

The hot melt adhesive is typically distributed and stored in its solid form and stored in the absence of moisture to prevent curing during storage. The invention also provides a method for bonding articles together which comprises providing the reactive hot melt adhesive at about room temperature in typically solid form; heating the reactive hot melt adhesive to a molten form; applying the molten reactive hot melt adhesive composition in molten form at a temperature in the range of from about 80° C. to about 145° C. to a first article; bringing a second article in contact with the molten composition applied to the first article; allowing the adhesive to cool and solidify; and subjecting the applied composition to conditions which will allow the composition to fully cure to a composition having an irreversible solid form. Solidification or setting occurs when the liquid melt begins to cool from its application temperature to room temperature. Curing of the composition to an irreversible solid form takes place over a period of 2 to 48 hours in the presence of ambient moisture available from the substrate surface or atmosphere and typically happens during and after solidification of the adhesive.

Thus, this disclosure includes reactive polyurethane hot melt adhesive compositions in both its uncured, solid form, as it is typically to be stored and distributed, its molten form after it has been melted just prior to its application and in its irreversibly solid form after curing.

The invention is further illustrated by the following non-limiting examples.

### EXAMPLES

The following components were utilized in the examples that follow.

| | |
|---|---|
| polyisocyanate | 4,4′-diphenylmethane-diisocyanate (MDI) |
| polyether | PPG2000 A polypropylene diol having a number |
| polyol | average molecular weight of 2,000 and an OH value |
| | of 56 from Covestro. |
| polyester | BD/AA with a number average molecular weight of |
| polyol A1 | 5,000 and acid number = 1.44 |
| polyester | BD/AA with a number average molecular weight of |
| polyol A2 | 5,000 and acid number = 2.35 |
| polyester | BD/AA with a number average molecular weight of |
| polyol A3 | 5,000 and acid number = 1.28 |
| polyester | BD/SuA, having a number average molecular weight |
| polyol B | of 3,500 and acid number = 3.87 |
| polyester | HD/SuA, with a number average molecular weight of |
| polyol C | 3,500 and acid number = 1.28 |
| polyester | HD/SA with a number average molecular weight of |
| polyol D | 3,500 and acid number = 1.92 |
| catalyst | 2,2′-dimorpholinodiethylether (DMDEE) available as |
| | Jeffcat DMDEE from Huntsman |
| filler A | CaCO₃, from Imerys Pigments and Additives |
| filler B | Kaolin clay |
| filler C | powdered dolomitic lime comprising 55% calcium |
| | carbonate and 45% magnesium carbonate. |
| thermoplastic | Elvacite 2016. A solid, methyl methacrylate n-butyl |
| polymer A | methacrylate acrylic copolymer with a weight average |
| | molecular weight of 60,000, Tg of 55° C., acid |
| | number about 3.5. Available from Lucite International. |
| thermoplastic | Elvacite 2013. A methyl methacrylate n-butyl |
| polymer B | methacrylate acrylic copolymer with a weight average |
| | molecular weight of 34,000, Tg of 76° C., acid |
| | number about 5. Available from Lucite International. |
| thermoplastic | Elvax 210. Ethylene Vinyl Acetate copolymer resin |
| polymer C | with a 28% vinyl acetate content, melting point 60° C., |
| | acid number about 0. Available from Dupont. |
| thermoplastic | DIANAL BR107. A methyl methacrylate n-butyl |
| polymer D | methacrylate acrylic copolymer with a weight average |
| | molecular weight of 75,000, Tg of 49° C. and acid |
| | number of 0. Available from Dianal America. |
| AA | adipic acid |
| BD | 1,4 butanediol |
| HD | 1,6 hexanediol |
| SA | sebacic acid |
| SuA | succinic acid |
| heat stabilizer A | STABAXOL I. Available from Lanxess |
| heat stabilizer B | N-tosylaziridine. Available from Sigma Aldrich |
| heat stabilizer C | Polyfunctional Aziridine PZ 33. Available from |
| | Polyaziridine LLC |
| heat stabilizer D | Bisphenol A liquid epoxy resin. DER 331 available |
| | from Olin |
| heat stabilizer E | STABAXOL P200. Available from Lanxess |
| heat stabilizer F | dicyclohexyl carbodiimide (DCC). Available from |
| | Sigma Aldrich. |
| heat stabilizer G | SILQUEST A-171. Available from Momentive. |
| heat stabilizer H | SILQUEST A-174. Available from Momentive. |
| heat stabilizer I | SILQUEST A-link 35. Available from Momentive. |
| heat stabilizer J | p-toluenesulfonyl isocyanate (PTSI). Available from |
| | VanDeMark Chemical Inc. |
| heat stabilizer K | chlorosulfonyl isocyanate (CSI). Available from Sigma |
| | Aldrich. |
| heat stabilizer L | trimethyl orthoformate (TMOF). Available from |
| | Evonik Industries. |
| heat stabilizer M | INCOZOL 2. Available from Incorez LTD. |

The viscosity was measured on a Brookfield DV-I+viscometer with a heated sample cup and using a #27 spindle at 121° C. after 30 minutes equilibration at temperature. Viscosity units are centipoise (cP).

Heat stability was measured using the following aging test. Initial viscosity of the hot melt adhesive is measured. A sample of uncured hot melt adhesive is filled into an aluminum tube and the tube is sealed to exclude air and moisture. The tube and sample are thermally aged in an oven at 121° C. for 24 hours. After aging the sample final viscosity is measured. Viscosity increase is calculated as (Viscosity_{final}−Viscosityᵢₙᵢₜᵢₐₗ)/Viscosityᵢₙᵢₜᵢₐₗ×100. The aging test is an approximation of how the hot melt adhesive will react when held at molten temperatures over time as would occur during commercial use. If the sample after thermal aging is gelled or phase separated the viscosity after aging is not measured and the heat stability is considered to be unacceptable and a fail.

Examples were prepared using the following general formula and are more explicitly described individually. In each case the materials are moisture reactive so the reactions, packaging and storage were done under conditions to exclude moisture.

| | Composition |
|---|---|
| Constituent | (Parts by Weight) |
| Polyether polyol | 26.99 |
| Polyester polyol | 14 |
| thermoplastic polymer | 19 |
| Filler | 25 |
| polyisocyanate | 14.6 |
| catalyst | <1.5 |
| heat stabilizer | <1.5 |

### Example 1—Comparative Base Adhesive

269.9 parts of a polyether polyol, 190.0 parts of thermoplastic polymer A, and 140.0 parts of polyester polyol A2 were introduced into a heatable stirred tank reactor with a vacuum connection and heated up to 121° C. to melt and dissolve therein. Moisture was then removed in vacuo over a period of 1.5 hours at 121° C. The reactor was then purged with nitrogen, 115.0 parts of 4,4′-diphenylmethane-diisocyanate (MDI) were added and the contents of the reactor were stirred for 15 minutes under nitrogen at 121° C., and then 3 hours in vacuo at 121° C. The reactor was purged with nitrogen, 1.1 parts of catalyst was added and stirred for 15 minutes under nitrogen. The reaction product was then transferred to a moisture proof container and immediately sealed without moisture. Initial viscosity was 11,630 cP. Final viscosity was 22,500 cP.

### Example 2—Comparative

269.9 parts of a polyether polyol, 190.0 parts of thermoplastic polymer A, 140.0 parts of polyester polyol A1, and 250.0 parts of filler A were introduced into a heatable stirred tank reactor with a vacuum connection and heated up to 121° C. to melt and dissolve therein. Moisture was then removed in vacuo over a period of 1.5 hours at 121° C. The reactor was then purged with nitrogen, 146.0 parts of 4,4′-diphenylmethane-diisocyanate (MDI) were added and the contents of the reactor were stirred for 15 minutes under nitrogen at 121° C., and then 3 hours in vacuo at 121° C. The reactor was purged with nitrogen, 1.1 parts of catalyst was added and stirred for 15 minutes under nitrogen. The reaction product was then transferred to a moisture proof container and immediately sealed without moisture. Initial viscosity was 26,050 cP. Final viscosity was not taken as material gelled during aging.

### Example 3—Comparative

269.9 parts of polyether polyol, 190.0 parts of thermoplastic polymer A, 140.0 parts of polyester polyol A2, and 250.0 parts of filler A were introduced into a heatable stirred tank reactor with a vacuum connection and heated up to 121° C. to melt and dissolve therein. Moisture was then removed in vacuo over a period of 1.5 hours at 121° C. The reactor was then purged with nitrogen, 146.0 parts of 4,4′-diphenylmethane-diisocyanate (MDI) were added and the contents of the reactor were stirred for 15 minutes under nitrogen at 121° C., and then in vacuo at 121° C. The reaction product gelled in reactor after 1.5 h in vacuo.

### Example 4—Comparative

269.9 parts of a polyether polyol, 190.0 parts of thermoplastic polymer A, 140.0 parts of polyester polyol B, and 250.0 parts of filler A were introduced into a heatable stirred tank reactor with a vacuum connection and heated up to 121° C. to melt and dissolve therein. Moisture was then removed in vacuo over a period of 1.5 hours at 121° C. The reactor was then purged with nitrogen, 146.0 parts of 4,4′-diphenylmethane-diisocyanate (MDI) were added and the contents of the reactor were stirred for 15 minutes under nitrogen at 121° C., and then in vacuo at 121° C. The reaction product gelled in reactor after 1.0 h in vacuo.

### Example 5—Comparative

269.9 parts of polyether polyol, 190.0 parts of thermoplastic polymer A, 140.0 parts of polyester polyol C, and 250.0 parts of filler A were introduced into a heatable stirred tank reactor with a vacuum connection and heated up to 121° C. to melt and dissolve therein. Moisture was then removed in vacuo over a period of 1.5 hours at 121° C. The reactor was then purged with nitrogen, 146.0 parts of 4,4′-diphenylmethane-diisocyanate (MDI) were added and the contents of the reactor were stirred for 15 minutes under nitrogen at 121° C., and then 3 hours in vacuo at 121° C. The reactor was purged with nitrogen, 1.1 parts of catalyst was added and stirred for 15 minutes under nitrogen. The reaction product was then transferred to a moisture proof container and immediately sealed without moisture. Initial viscosity was 18,500 cP. Final viscosity was not taken as material gelled during aging.

### Example 6—Comparative

269.9 parts of a polyether polyol, 190.0 parts of thermoplastic polymer A, 140.0 parts of polyester polyol D (acid value 1.92), and 250.0 parts of filler A were introduced into a heatable stirred tank reactor with a vacuum connection and heated up to 121° C. to melt and dissolve therein. Moisture was then removed in vacuo over a period of 1.5 hours at 121° C. The reactor was then purged with nitrogen, 146.0 parts of 4,4′-diphenylmethane-diisocyanate (MDI) were added and the contents of the reactor were stirred for 15 minutes under nitrogen at 121° C., and then 3 hours in vacuo at 121° C. The reactor was purged with nitrogen, 1.1 parts of 2,2′-dimorpholinildiethylether (DMDEE) was added and stirred for 15 minutes under nitrogen. The reaction product was then transferred to a moisture proof container and sealed immediately for later test.

### Example 7—Inventive

140.0 parts of polyester polyol A2 was introduced into a heatable stirred tank reactor with a vacuum connection and heated up to 121° C. to melt, then 5.0 parts of heat stabilizer A was melted and introduced into the tank reactor. After pretreatment for 1.0 hour under nitrogen at 121° C., 269.9 parts of polyether polyol, 190.0 parts of thermoplastic polymer A and 250.0 parts of filler A were introduced and mixed therein. Moisture was then removed in vacuo over a period of 1.5 hours at 121° C. The reactor was then purged with nitrogen, 146.0 parts of 4,4′-diphenylmethane-diisocyanate (MDI) were added and the contents of the reactor were stirred for 15 minutes under nitrogen at 121° C., and then 3 hours in vacuo at 121° C. The reactor was purged with nitrogen, 1.1 parts of catalyst was added and stirred for 15 minutes under nitrogen. The reaction product was then transferred to a moisture proof container and sealed immediately for later test. Initial viscosity was 11,150 cP. Final viscosity was 25,900 cP.

### Example 8—Inventive

269.9 parts of polyether polyol and 140.0 parts of polyester polyol A2 were introduced into a heatable stirred tank reactor with a vacuum connection and heated up to 121° C. to melt, then 5.0 parts of heat stabilizer A was melted and introduced into the tank reactor. After pretreatment for 1.0 hour under nitrogen at 121° C., 190.0 parts of thermoplastic polymer A and 250.0 parts of filler A were introduced and mixed therein. Moisture was then removed in vacuo over a period of 1.5 hours at 121° C. The reactor was then purged with nitrogen, 146.0 parts of 4,4′-diphenylmethane-diisocyanate (MDI) were added and the contents of the reactor were stirred for 15 minutes under nitrogen at 121° C., and then 3 hours in vacuo at 121° C. The reactor was purged with nitrogen, 1.1 parts of catalyst was added and stirred for 15 minutes under nitrogen. The reaction product was then transferred to a moisture proof container and sealed immediately for later test. Initial viscosity was 8,800 cP. Final viscosity was 21,500 cP.

### Example 9—Inventive

269.9 parts of polyether polyol, 140.0 parts of polyester polyol A2 and 190.0 parts of thermoplastic polymer A were introduced into a heatable stirred tank reactor with a vacuum connection and heated up to 121° C. to melt, then 5.0 parts of heat stabilizer A was melted and introduced into the tank reactor. After pretreatment for 1.0 hour under nitrogen at 121° C., 250.0 parts of filler A was introduced and mixed therein. Moisture was then removed in vacuo over a period of 1.5 hours at 121° C. The reactor was then purged with nitrogen, 146.0 parts of 4,4′-diphenylmethane-diisocyanate (MDI) were added and the contents of the reactor were stirred for 15 minutes under nitrogen at 121° C., and then 3 hours in vacuo at 121° C. The reactor was purged with nitrogen, 1.1 parts of catalyst was added and stirred for 15 minutes under nitrogen. The reaction product was then transferred to a moisture proof container and sealed immediately for later test. Initial viscosity was 10,380 cP. Final viscosity was 28,900 cP.

### Example 10—Comparative

269.9 parts of polyether polyol, 140.0 parts of polyester polyol A2, and 190.0 parts of thermoplastic resin A were introduced into a heatable stirred tank reactor with a vacuum connection and heated up to 121° C. to melt, then 5.0 parts of heat stabilizer A was melted and introduced into the tank reactor. After pretreatment for 35.0 minutes under nitrogen at 121° C., 250.0 parts of filler A was introduced and mixed therein. Moisture was then removed in vacuo over a period of 1.5 hours at 121° C. The reactor was then purged with nitrogen, 146.0 parts of 4,4′-diphenylmethane-diisocyanate (MDI) were added and the contents of the reactor were stirred for 15 minutes under nitrogen at 121° C., and then 3 hours in vacuo at 121° C. The reactor was purged with nitrogen, 1.1 parts of catalyst was added and stirred for 15 minutes under nitrogen. The reaction product was then transferred to a moisture proof container and sealed immediately for later test. Initial viscosity was 11,500. The material phase separated during the aging test. This is considered a failure.

### Example 11—Comparative

269.9 parts of polyether polyol, 140.0 parts of polyester polyol A2 and 190.0 parts of thermoplastic polymer A were introduced into a heatable stirred tank reactor with a vacuum connection and heated up to 121° C. to melt, then 5.0 parts of heat stabilizer A was melted and introduced into the tank reactor. After pretreatment for 15.0 minutes under nitrogen at 121° C., 250.0 parts of filler A were introduced and mixed therein. Moisture was then removed in vacuo over a period of 1.5 hours at 121° C. The reactor was then purged with nitrogen, 146.0 parts of 4,4′-diphenylmethane-diisocyanate (MDI) were added and the contents of the reactor were stirred for 15 minutes under nitrogen at 121° C., and then 3 hours in vacuo at 121° C. The reactor was purged with nitrogen, 1.1 parts of catalyst was added and stirred for 15 minutes under nitrogen. The reaction product was then transferred to a moisture proof container and sealed immediately for later test. Initial viscosity was 11,500. The material phase separated and gelled during the aging test. This is considered a failure.

### Example 12—Comparative

269.9 parts of, 140.0 parts of polyester polyol A2 and 250.0 parts of filler A was introduced into a heatable stirred tank reactor with a vacuum connection and heated up to 121° C. to melt, then 5.0 parts of heat stabilizer A was melted and introduced into the tank reactor. After pretreatment for 1.0 hour under nitrogen at 121° C., 190.0 parts of thermoplastic polymer A was introduced and mixed therein. Moisture was then removed in vacuo over a period of 1.5 hours at 121° C. The reactor was then purged with nitrogen, 146.0 parts of 4,4′-diphenylmethane-diisocyanate (MDI) were added and the contents of the reactor were stirred for 15 minutes under nitrogen at 121° C., and then 3 hours in vacuo at 121° C. The reactor was purged with nitrogen, 1.1 parts of catalyst was added and stirred for 15 minutes under nitrogen. The reaction product was then transferred to a moisture proof container and sealed immediately for later test. Initial viscosity was 8,800. The material phase separated and gelled during the aging test. This is considered a failure.

### Example 13—Comparative

269.9 parts of, 140.0 parts of polyester polyol A2 and 250.0 parts of filler A were introduced into a heatable stirred tank reactor with a vacuum connection and heated up to 121° C. to melt, moisture was then removed in vacuo over a period of 1.5 hours at 121° C. Then 5.0 parts of heat stabilizer A was melted and introduced into the tank reactor. After pretreatment for 1.0 hour under nitrogen at 121° C., 190.0 parts of thermoplastic polymer A was introduced and mixed therein. Moisture was then removed in vacuo over a period of 1.5 hours at 121° C. The reactor was then purged with nitrogen, 146.0 parts of 4,4′-diphenylmethane-diisocyanate (MDI) were added and the contents of the reactor were stirred for 15 minutes under nitrogen at 121° C., and then 3 hours in vacuo at 121° C. The reactor was purged with nitrogen, 1.1 parts of catalyst was added and stirred for 15 minutes under nitrogen. The reaction product was then transferred to a moisture proof container and sealed immediately for later test. Initial viscosity was 9,700. The material phase separated during the aging test. This is considered a failure.

### Example 14—Inventive

269.9 parts of 190.0 parts of thermoplastic polymer A and 250.0 parts of filler A were introduced into a heatable stirred tank reactor with a vacuum connection and heated up to 121° C. to melt, then 5.0 parts of heat stabilizer A was melted and introduced into the tank reactor. After pretreatment for 1.0 hour under nitrogen at 121° C., 140.0 parts of polyester polyol A2 was introduced and mixed therein. Moisture was then removed in vacuo over a period of 1.5 hours at 121° C. The reactor was then purged with nitrogen, 146.0 parts of 4,4′-diphenylmethane-diisocyanate (MDI) were added and the contents of the reactor were stirred for 15 minutes under nitrogen at 121° C., and then 3 hours in vacuo at 121° C. The reactor was purged with nitrogen, 1.1 parts of catalyst was added and stirred for 15 minutes under nitrogen. The reaction product was then transferred to a moisture proof container and sealed immediately for later test. Initial viscosity was 12,650. Final viscosity was 48,800.

### Example 15—Comparative

269.9 parts of polyether polyol, 140.0 parts of polyester polyol A2, 190.0 parts of thermoplastic polymer A, and 250.0 parts of filler A were introduced into a heatable stirred tank reactor with a vacuum connection and heated up to 121° C. to melt, then 5.0 parts of heat stabilizer A was melted and introduced into the tank reactor. After pretreatment for 1.0 hour under nitrogen at 121° C., moisture was then removed in vacuo over a period of 1.5 hours at 121° C. The reactor was then purged with nitrogen, 146.0 parts of 4,4′-diphenylmethane-diisocyanate (MDI) was added and the contents of the reactor were stirred for 15 minutes under nitrogen at 121° C., and then 3 hours in vacuo at 121° C. The reactor was purged with nitrogen, 1.1 parts of catalyst was added and stirred for 15 minutes under nitrogen. The reaction product was then transferred to a moisture proof container and sealed immediately for later test. Initial viscosity was 10,780. The material gelled during the aging test. This is considered a failure.

### Example 16—Comparative

269.9 parts of polyether polyol, 140.0 parts of polyester polyol A2, 190.0 parts of thermoplastic polymer A and 250.0 parts of filler A were introduced into a heatable stirred tank reactor with a vacuum connection and heated up to 121° C. to melt, then 12.0 parts of heat stabilizer A was melted and introduced into the tank reactor. After pretreatment for 1.0 hour under nitrogen at 121° C., moisture was then removed in vacuo over a period of 1.5 hours at 121° C. The reactor was then purged with nitrogen, 146.0 parts of 4,4′-diphenylmethane-diisocyanate (MDI) was added and the contents of the reactor were stirred for 15 minutes under nitrogen at 121° C., and then 3 hours in vacuo at 121° C. The reactor was purged with nitrogen, 1.1 parts of catalyst was added and stirred for 15 minutes under nitrogen. The reaction product was then transferred to a moisture proof container and sealed immediately for later test. Initial viscosity was 9,650. The material gelled during the aging test. This is considered a failure.

### Example 17—Comparative

269.9 parts of polyether polyol and 190.0 parts of thermoplastic polymer A were introduced into a heatable stirred tank reactor with a vacuum connection and heated up to 121° C. to melt, then 5.0 parts of heat stabilizer A was melted and introduced into the tank reactor. After pretreatment for 1.0 hour under nitrogen at 121° C., 140.0 parts of polyester polyol A2 and 250.0 parts of filler A were introduced and mixed therein. Moisture was then removed in vacuo over a period of 1.5 hours at 121° C. The reactor was then purged with nitrogen, 146.0 parts of 4,4′-diphenylmethane-diisocyanate (MDI) were added and the contents of the reactor were stirred for 15 minutes under nitrogen at 121° C., and then 3 hours in vacuo at 121° C. The reactor was purged with nitrogen, 1.1 parts of catalyst was added and stirred for 15 minutes under nitrogen. The reaction product was then transferred to a moisture proof container and sealed immediately for later test. Initial viscosity was 12,500. Final viscosity was 133,500.

### Example 18—Comparative

140.0 parts of polyester polyol A2 and 250.0 parts of filler A were introduced into a heatable stirred tank reactor with a vacuum connection and heated up to 121° C. to melt, then 5.0 parts of heat stabilizer A was melted and introduced into the tank reactor. After pretreatment for 1.0 hour under nitrogen at 121° C., 269.9 parts of a polyether polyol and 190.0 parts of thermoplastic polymer A were introduced and mixed therein. Moisture was then removed in vacuo over a period of 1.5 hours at 121° C. The reactor was then purged with nitrogen, 146.0 parts of 4,4′-diphenylmethane-diisocyanate (MDI) was added and the contents of the reactor were stirred for 15 minutes under nitrogen at 121° C., and then 3 hours in vacuo at 121° C. The reactor was purged with nitrogen, 1.1 parts of catalyst was added and stirred for 15 minutes under nitrogen. The reaction product was then transferred to a moisture proof container and sealed immediately for later test. Initial viscosity was 13,275. Final viscosity was 124,500.

### Example 19—Comparative

269.9 parts of polyether polyol and 250.0 parts of filler A were introduced into a heatable stirred tank reactor with a vacuum connection and heated up to 121° C. to melt, then 5.0 parts of heat stabilizer A was melted and introduced into the tank reactor. After pretreatment for 1.0 hour under nitrogen at 121° C., 140.0 parts of polyester polyol A2 and 190.0 parts of thermoplastic polymer A were introduced and mixed therein. Moisture was then removed in vacuo over a period of 1.5 hours at 121° C. The reactor was then purged with nitrogen, 146.0 parts of 4,4′-diphenylmethane-diisocyanate (MDI) was added and the contents of the reactor were stirred for 15 minutes under nitrogen at 121° C., and then 3 hours in vacuo at 121° C. The reactor was purged with nitrogen, 1.1 parts of catalyst was added and stirred for 15 minutes under nitrogen. The reaction product was then transferred to a moisture proof container and sealed immediately for later test. Initial viscosity was 12,380. The material after aging was barely flowable with an extremely high viscosity. This is considered a failure.

### Example 20—Comparative

269.9 parts of polyether polyol and 250.0 parts of filler A were introduced into a heatable stirred tank reactor with a vacuum connection and heated up to 140° C. and dispersed for 1.5 h at 140° C. Then the temperature was decreased to 121° C. and 5.0 parts of heat stabilizer A was melted and introduced into the tank reactor. After pretreatment for 1.0 hour under nitrogen at 121° C., 140.0 parts of polyester polyol A2 and 190.0 parts of thermoplastic polymer A were introduced and mixed therein. Moisture was then removed in vacuo over a period of 1.5 hours at 121° C. The reactor was then purged with nitrogen, 146.0 parts of 4,4′-diphenylmethane-diisocyanate (MDI) were added and the contents of the reactor were stirred for 15 minutes under nitrogen at 121° C., and then 3 hours in vacuo at 121° C. The reactor was purged with nitrogen, 1.1 parts of catalyst was added and stirred for 15 minutes under nitrogen. The reaction product was then transferred to a moisture proof container and sealed immediately for later test. Initial viscosity was 8,950. The material separated during aging. This is considered a failure.

### Example 21—Comparative

269.9 parts of polyether polyol and 140.0 parts of polyester polyol A2 were introduced into a heatable stirred tank reactor with a vacuum connection and heated up to 121° C. to melt, then 5.0 parts of heat stabilizer B was introduced into the tank reactor. After pretreatment for 1.0 hour under nitrogen at 121° C., 190.0 parts of thermoplastic polymer A and 250.0 parts of filler A were introduced and mixed therein. Moisture was then removed in vacuo over a period of 1.5 hours at 121° C. The reactor was then purged with nitrogen, 146.0 parts of 4,4′-diphenylmethane-diisocyanate (MDI) was added and the contents of the reactor were stirred for 15 minutes under nitrogen at 121° C., and then in vacuo at 121° C. The reaction product gelled in reactor after about 1.5 h in vacuo. This is considered a failure.

### Example 22—Inventive

140.0 parts of polyester polyol B was introduced into a heatable stirred tank reactor with a vacuum connection and heated up to 121° C. to melt, then 5.0 parts of heat stabilizer A was melted and introduced into the tank reactor. After pretreatment for 1.0 hour under nitrogen at 121° C., 269.9 parts of polyether polyol, 190.0 parts of thermoplastic polymer A, and 250.0 parts of filler A were introduced and mixed therein. Moisture was then removed in vacuo over a period of 1.5 hours at 121° C. The reactor was then purged with nitrogen, 146.0 parts of 4,4′-diphenylmethane-diisocyanate (MDI) was added and the contents of the reactor were stirred for 15 minutes under nitrogen at 121° C., and then 3 hours in vacuo at 121° C. The reactor was purged with nitrogen, 1.1 parts of catalyst was added and stirred for 15 minutes under nitrogen. The reaction product was then transferred to a moisture proof container and sealed immediately for later test. Initial viscosity was 15,630. Final viscosity was 32,600.

### Example 23—Inventive

140.0 parts of polyester polyol C was introduced into a heatable stirred tank reactor with a vacuum connection and heated up to 121° C. to melt, then 5.0 parts of heat stabilizer A was melted and introduced into the tank reactor. After pretreatment for 1.0 hour under nitrogen at 121° C., 269.9 parts of polyether polyol, 190.0 parts of thermoplastic polymer A, and 250.0 parts of filler A were introduced and mixed therein. Moisture was then removed in vacuo over a period of 1.5 hours at 121° C. The reactor was then purged with nitrogen, 146.0 parts of 4,4′-diphenylmethane-diisocyanate (MDI) was added and the contents of the reactor were stirred for 15 minutes under nitrogen at 121° C., and then 3 hours in vacuo at 121° C. The reactor was purged with nitrogen, 1.1 parts of catalyst was added and stirred for 15 minutes under nitrogen. The reaction product was then transferred to a moisture proof container and sealed immediately for later test. Initial viscosity was 11,150. Final viscosity was 33,900.

### Example 24—Comparative

269.9 parts of polyether polyol and 140.0 parts of polyester polyol A1 were introduced into a heatable stirred tank reactor with a vacuum connection and heated up to 121° C. to melt, then 9.0 parts of heat stabilizer C was introduced into the tank reactor. After pretreatment for 1.0 hour under nitrogen at 121° C., 190.0 parts of thermoplastic polymer A and 250.0 parts of filler A were introduced and mixed therein. Moisture was then being removed in vacuo; the blend gelled during the vacuum dry and before addition of any polyisocyanate or catalyst. This is considered a failure.

### Example 25—Comparative

140.0 parts of polyester polyol A2 was introduced into a heatable stirred tank reactor with a vacuum connection and heated up to 121° C. to melt, then 1.0 part of heat stabilizer C was melted and introduced into the tank reactor. After pretreatment for 1.0 hour under nitrogen at 121° C., 269.9 parts of polyether polyol, 190.0 parts of thermoplastic polymer A, and 250.0 parts of filler A were introduced and mixed therein. Moisture was then removed in vacuo over a period of 1.5 hours at 121° C. The reactor was then purged with nitrogen, 146.0 parts of 4,4′-diphenylmethane-diisocyanate (MDI) was added and the contents of the reactor were stirred for 15 minutes under nitrogen at 121° C., and then in vacuo at 121° C. The reaction product gelled in reactor after 1.5 h in vacuo and before any addition of catalyst. This is considered a failure.

### Example 26—Comparative

269.9 parts of polyether polyol and 140.0 parts of polyester polyol A1 were introduced into a heatable stirred tank reactor with a vacuum connection and heated up to 121° C. to melt, then 0.7 parts of heat stabilizer D was melted and introduced into the tank reactor. After pretreatment for 1.0 hour under nitrogen at 121° C., 190.0 parts of thermoplastic polymer A and 250.0 parts of filler A were introduced and mixed therein. Moisture was then removed in vacuo over a period of 1.5 hours at 121° C. The reactor was then purged with nitrogen, 146.0 parts of 4,4′-diphenylmethane-diisocyanate (MDI) was added and the contents of the reactor were stirred for 15 minutes under nitrogen at 121° C., and then 3 hours in vacuo at 121° C. The reactor was purged with nitrogen, 1.1 parts of catalyst was added and stirred for 15 minutes under nitrogen. The reaction product was then transferred to a moisture proof container and sealed immediately for later test. Initial viscosity was 13,750. The material gelled during aging. This is considered a failure.

### Example 27—Comparative

269.9 parts of polyether polyol and 140.0 parts of polyester polyol A1 were introduced into a heatable stirred tank reactor with a vacuum connection and heated up to 121° C. to melt, then 9.0 parts of heat stabilizer D was melted and introduced into the tank reactor. After pretreatment for 1.0 hour under nitrogen at 121° C., 190.0 parts of thermoplastic polymer A and 250.0 parts of filler A were introduced and mixed therein. Moisture was then removed in vacuo over a period of 1.5 hours at 121° C. The reactor was then purged with nitrogen, 146.0 parts of 4,4′-diphenylmethane-diisocyanate (MDI) was added and the contents of the reactor were stirred for 15 minutes under nitrogen at 121° C., and then 3 hours in vacuo at 121° C. The reactor was purged with nitrogen, 1.1 parts of catalyst was added and stirred for 15 minutes under nitrogen. The reaction product was then transferred to a moisture proof container and sealed immediately for later test. Initial viscosity was 17,480. The material gelled during aging. This is considered a failure.

### Example 28—Inventive

140.0 parts of polyester polyol C was introduced into a heatable stirred tank reactor with a vacuum connection and heated up to 121° C. to melt, then 5.0 parts of heat stabilizer A was melted and introduced into the tank reactor. After pretreatment for 1.0 hour under nitrogen at 121° C., 269.9 parts of polyether polyol, 190.0 parts of thermoplastic polymer A and 250.0 parts of filler B were introduced and mixed therein. Moisture was then removed in vacuo over a period of 1.5 hours at 121° C. The reactor was then purged with nitrogen, 146.0 parts of 4,4′-diphenylmethane-diisocyanate (MDI) was added and the contents of the reactor were stirred for 15 minutes under nitrogen at 121 C, and then 3 hours in vacuo at 121 C. The reactor was purged with nitrogen, 1.1 parts of catalyst was added and stirred for 15 minutes under nitrogen. The reaction product was then transferred to a moisture proof container and sealed immediately for later test. Initial viscosity was 18,750. Final viscosity was 62,400.

### Example 29—Inventive

140.0 parts of polyester polyol C was introduced into a heatable stirred tank reactor with a vacuum connection and heated up to 121° C. to melt, then 5.0 parts of heat stabilizer A was melted and introduced into the tank reactor. After pretreatment for 1.0 hour under nitrogen at 121° C., 269.9 parts of polyether polyol, 190.0 parts of thermoplastic polymer A and 250.0 parts of filler C were introduced and mixed therein. Moisture was then removed in vacuo over a period of 1.5 hours at 121° C. The reactor was then purged with nitrogen, 146.0 parts of 4,4′-diphenylmethane-diisocyanate (MDI) was added and the contents of the reactor were stirred for 15 minutes under nitrogen at 121° C., and then 3 hours in vacuo at 121° C. The reactor was purged with nitrogen, 1.1 parts of catalyst was added and stirred for 15 minutes under nitrogen. The reaction product was then transferred to a moisture proof container and sealed immediately for later test. Initial viscosity was 10,600. Final viscosity was 18,750.

### Example 30—Comparative

269.9 parts of polyether polyol, 190.0 parts of thermoplastic polymer A, 140.0 parts of polyester polyol C and 250.0 parts of filler B were introduced into a heatable stirred tank reactor with a vacuum connection and heated up to 121° C. to melt and dissolve therein. Moisture was then removed in vacuo over a period of 1.5 hours at 121° C. The reactor was then purged with nitrogen, 146.0 parts of 4,4′-diphenylmethane-diisocyanate (MDI) was added and the contents of the reactor were stirred for 15 minutes under nitrogen at 121° C., and then 3 hours in vacuo at 121° C. The reactor was purged with nitrogen, 1.1 parts of catalyst was added and stirred for 15 minutes under nitrogen. The reaction product was then transferred to a moisture proof container and sealed immediately for later test. Initial viscosity was 32,250. The material gelled during aging. This is considered a failure.

### Example 31—Comparative

269.9 parts of polyether polyol, 190.0 parts of thermoplastic polymer A, 140.0 parts of polyester polyol C and 250.0 parts of filler C were introduced into a heatable stirred tank reactor with a vacuum connection and heated up to 121° C. to melt and dissolve therein. Moisture was then removed in vacuo over a period of 1.5 hours at 121° C. The reactor was then purged with nitrogen, 146.0 parts of 4,4′-diphenylmethane-diisocyanate (MDI) was added and the contents of the reactor were stirred for 15 minutes under nitrogen at 121° C., and then 3 hours in vacuo at 121° C. The reactor was purged with nitrogen, 1.1 parts of catalyst was added and stirred for 15 minutes under nitrogen. The reaction product was then transferred to a moisture proof container and sealed immediately for later test. Initial viscosity was 8,350. The material gelled during aging. This is considered a failure.

### Example 32—Comparative

269.9 parts of polyether polyol, 190.0 parts of thermoplastic polymer C and 250.0 parts of filler A were introduced into a heatable stirred tank reactor with a vacuum connection and heated up to 121° C. to melt, then 5.0 parts of heat stabilizer A was melted and introduced into the tank reactor. After pretreatment for 1.0 hour under nitrogen at 121° C., 140.0 parts of polyester polyol C was introduced and mixed therein. Moisture was then removed in vacuo over a period of 1.5 hours at 121° C. The reactor was then purged with nitrogen, 146.0 parts of 4,4′-diphenylmethane-diisocyanate (MDI) were added and the contents of the reactor were stirred for 15 minutes under nitrogen at 121° C., and then 3 hours in vacuo at 121° C. The reactor was purged with nitrogen, 1.1 parts of catalyst was added and stirred for 15 minutes under nitrogen. The reaction product was then transferred to a moisture proof container and sealed immediately for later test. Initial viscosity was 10,900. The material gelled during aging. This is considered a failure.

It was visually observed that the filler in this Example did not disperse well in the polyether polyol and thermoplastic polymer C (Elvax 210) mixture. It is believed that this led to an incomplete treatment of the filler by the heat stabilizer and contributed at least partially to gelling of the aged material.

### Example 33—Comparative

140.0 parts of polyester polyol C was introduced into a heatable stirred tank reactor with a vacuum connection and heated up to 121° C. to melt, then 5.0 parts of heat stabilizer A was melted and introduced into the tank reactor. After pretreatment for 1.0 hour under nitrogen at 121° C., 269.9 parts of polyether polyol, 190.0 parts of thermoplastic polymer C and 250.0 parts of filler A were introduced and mixed therein. Moisture was then removed in vacuo over a period of 1.5 hours at 121° C. The reactor was then purged with nitrogen, 146.0 parts of 4,4′-diphenylmethane-diisocyanate (MDI) was added and the contents of the reactor were stirred for 15 minutes under nitrogen at 121° C., and then 3 hours in vacuo at 121° C. The reactor was purged with nitrogen, 1.1 parts of catalyst was added and stirred for 15 minutes under nitrogen. The reaction product was then transferred to a moisture proof container and sealed immediately for later test. Initial viscosity was 9,750. The material gelled during aging. This is considered a failure.

Despite treatment of the polyester polyol with heat stabilizer the presence of thermoplastic polymer C appears to deleteriously affect stability of the system.

### Example 34—Inventive

269.9 parts of polyether polyol, 190.0 parts of thermoplastic polymer A, and 250.0 parts of filler B were introduced into a heatable stirred tank reactor with a vacuum connection and heated up to 121° C. to melt, then 5.0 parts of heat stabilizer A was melted and introduced into the tank reactor. After pretreatment for 1.0 hour under nitrogen at 121° C., 140.0 parts of polyester polyol C was introduced and mixed therein. Moisture was then removed in vacuo over a period of 1.5 hours at 121° C. The reactor was then purged with nitrogen, 146.0 parts of 4,4′-diphenylmethane-diisocyanate (MDI) was added and the contents of the reactor were stirred for 15 minutes under nitrogen at 121° C., and then 3 hours in vacuo at 121° C. The reactor was purged with nitrogen, 1.1 parts of catalyst was added and stirred for 15 minutes under nitrogen. The reaction product was then transferred to a moisture proof container and sealed immediately for later test. Initial viscosity was 17,050. Final viscosity was 46,630.

### Example 35—Inventive

269.9 parts of polyether polyol, 190.0 parts of thermoplastic polymer A, and 250.0 parts of filler C were introduced into a heatable stirred tank reactor with a vacuum connection and heated up to 121° C. to melt, then 5.0 parts of heat stabilizer A was melted and introduced into the tank reactor. After pretreatment for 1.0 hour under nitrogen at 121° C., 140.0 parts of polyester polyol C was introduced and mixed therein. Moisture was then removed in vacuo over a period of 1.5 hours at 121° C. The reactor was then purged with nitrogen, 146.0 parts of 4,4′-diphenylmethane-diisocyanate (MDI) were added and the contents of the reactor were stirred for 15 minutes under nitrogen at 121° C., and then 3 hours in vacuo at 121° C. The reactor was purged with nitrogen, 1.1 parts of catalyst was added and stirred for 15 minutes under nitrogen. The reaction product was then transferred to a moisture proof container and sealed immediately for later test. Initial viscosity was 10,850. Final viscosity was 23,430.

### Example 36—Comparative

140.0 parts of polyester polyol C was introduced into a heatable stirred tank reactor with a vacuum connection and heated up to 121° C. to melt, then 5.0 parts of heat stabilizer A was melted and introduced into the tank reactor. After pretreatment for 1.0 hour under nitrogen at 121° C., 269.9 parts of polyether polyol and 250.0 parts of filler A were introduced and therein. Moisture was then removed in vacuo over a period of 1.5 hours at 121° C. The reactor was then purged with nitrogen, 146.0 parts of 4,4′-diphenylmethane-diisocyanate (MDI) were added and the contents of the reactor were stirred for 15 minutes under nitrogen at 121° C., and then 3 hours in vacuo at 121° C. The reactor was purged with nitrogen, 1.1 parts of catalyst was added and stirred for 15 minutes under nitrogen. The reaction product was then transferred to a moisture proof container and sealed immediately for later test. Initial viscosity was 895. The material separated and gelled during aging. This is considered a failure.

### Example 37—Inventive

269.9 parts of polyether polyol, 190.0 parts of thermoplastic polymer B and 250.0 parts of filler A were introduced into a heatable stirred tank reactor with a vacuum connection and heated up to 121° C. to melt, then 5.0 parts of heat stabilizer A was melted and introduced into the tank reactor. After pretreatment for 1.0 hour under nitrogen at 121° C., 140.0 parts of polyester polyol C was introduced and mixed therein. Moisture was then removed in vacuo over a period of 1.5 hours at 121° C. The reactor was then purged with nitrogen, 146.0 parts of 4,4′-diphenylmethane-diisocyanate (MDI) was added and the contents of the reactor were stirred for 15 minutes under nitrogen at 121° C., and then 3 hours in vacuo at 121° C. The reactor was purged with nitrogen, 1.1 parts of catalyst was added and stirred for 15 minutes under nitrogen. The reaction product was then transferred to a moisture proof container and sealed immediately for later test. Initial viscosity was 4,550. Final viscosity was 13,150.

The following Table lists compositions and results for the above examples.

| | | 1st mix | | | | | | 2nd mix | | | |
|---|---|---|---|---|---|---|---|---|---|---|---|
| | | | | PeP | | | ht | | | | result |
| Ex. | type | PPG | PeP | acid # | TP | filler | stab | PeP | TP | filler | % |
| 1 | std | PPG | A2 | 2.35 | A | none | none | none | none | none | 94 |
| 2 | C | PPG | A1 | 1.44 | A | A | none | none | none | none | g-a |
| 3 | C | PPG | A2 | 2.35 | A | A | none | none | none | none | g-r |
| 4 | C | PPG | B | 3.87 | A | A | none | none | none | none | g-r |
| 5 | C | PPG | C | 1.28 | A | A | none | none | none | none | g-a |
| 6 | C | PPG | D | 1.92 | A | A | none | none | none | none | 98 |
| 7 | I | none | A2 | 2.35 | none | none | A | none | A | A | 132 |
| 8 | I | PPG | A2 | 2.35 | none | none | A | none | A | A | 144 |
| 9 | I | PPG | A2 | 2.35 | A | none | A | none | none | A | 178 |
| 10 | C | PPG | A2 | 2.35 | A | none | A | none | none | A | s-a |
| 11 | C | PPG | A2 | 2.35 | A | none | A | none | none | A | s&g-a |
| 12 | C | PPG | A2 | 2.35 | none | A | A | none | A | none | s&g-a |
| 13 | C | PPG | A2 | 2.35 | none | A | A | none | A | none | s-a |
| 14 | I | PPG | none | | A | A | A | A2 | none | none | 286 |
| 15 | C | PPG | A2 | 2.35 | A | A | A | none | none | none | g-a |
| 16 | C | PPG | A2 | 2.35 | A | A | A | none | none | none | g-a |
| 17 | C | PPG | none | | A | none | A | A2 | none | A | 968 |
| 18 | C | none | A2 | 2.35 | none | A | A | none | A | none | 838 |
| 19 | C | PPG | none | | none | A | A | A2 | A | none | — |
| 20 | C | PPG | none | | none | A | A | A2 | A | none | s-a |
| 21 | C | PPG | A2 | 2.35 | none | none | B | none | A | A | g-r |
| 22 | I | none | B | 3.87 | none | none | A | none | A | A | 109 |
| 23 | I | none | C | 1.28 | none | none | A | none | A | A | 204 |
| 24 | C | PPG | A1 | 2.35 | none | none | C | none | A | A | g-r |
| 25 | C | none | A2 | 2.35 | none | none | D | none | A | A | g-r |
| 26 | C | PPG | A1 | 1.44 | none | none | D | none | A | A | g-a |
| 27 | C | PPG | A1 | 1.44 | none | none | D | none | A | A | g-a |
| 28 | I | none | C | 1.28 | none | none | A | none | A | B | 233 |
| 29 | I | none | C | 1.28 | none | none | A | none | A | C | 77 |
| 30 | C | PPG | C | 1.28 | A | B | A | none | none | none | g-a |
| 31 | C | PPG | C | 1.28 | A | C | none | none | none | none | g-a |
| 32 | C | PPG | none | | C | A | A | C | none | none | g-a |
| 33 | C | none | C | 1.28 | none | none | A | none | C | A | g-a |
| 34 | I | PPG | none | | A | B | A | C | none | none | 173 |
| 35 | I | PPG | none | | A | C | A | C | none | none | 116 |
| 36 | C | none | C | 1.28 | none | none | A | none | none | A | g&s-a |
| 37 | I | PPG | none | | B | A | A | C | none | none | 189 |

type C is comparative, type I is inventive
PPG is polyether polyol; PeP is polyester polyol; TP is thermoplastic polymer; ht stab is heat stabilizer.
result is % viscosity increase after aging; g-a gel during aging; g-r gel during reaction; s-a separate during aging

Examples 1 to 5 show that adding filler and polyester polyols to a reactive polyurethane hot melt adhesive composition can significantly degrade the heat stability of that hot melt composition. In the worst case a composition will gel during reaction.

Example 6 surprisingly shows that for polyester polyols of the formula H—[O(CH2)m OOC(CH2)n CO]k-O(CH2)p-OH, when the sum of m+n is over 10, the moisture reactive, filled hot melt polyurethane composition made using these polyester polyols can be quite stable and there is no need for a heat stabilizer.

Examples 7, 8 and 9 show that if polyester polyol is pretreated with carbodiimide heat stabilizer, stability of the resulting hot melt composition is surprisingly improved. The examples also show that the polyester polyol can be pretreated alone or it can be pretreated with PPG and/or thermoplastic polymer. Note that filler is not in the mixture during pretreatment with heat stabilizer in these Examples.

Examples 10 and 11 show that the heat stabilizer pretreatment has to be performed for a sufficient time (more than 35 mins). A shortened pretreatment time will not be effective to prevent separation and/or gelling of the composition.

Examples 12 and 13 surprisingly show that pretreatment with heat stabilizer is not effective if both polyester polyol and filler are present in the mixture with PPG.

Example 14 shows that pretreatment with heat stabilizer is effective for mixtures of PPG, filler and thermoplastic polymer A. Surprisingly, the filler does not contain any reactive group to react with the carbodiimide heat stabilizer.

Examples 15 to 18 again surprisingly show that pretreatment with heat stabilizer is not effective if both polyester polyol and filler are present in the treatment mixture.

Examples 19 and 20 illustrate the effect dispersal of the filler in the treatment mixture. In these Examples the filler in this Example did not disperse well in the polypropylene glycol, leaving clusters or aggregates of filler in the polypropylene glycol and not a homogeneous dispersion of singular filler particles. It is believed that this led to an incomplete treatment of the filler by the heat stabilizer and resulted in the very high viscosity of the aged material. The higher temperature of example 20 helped disperse the filler and provide a better treatment of the filler by the heat stabilizer. The result was better than Example 19 but still an unacceptable separation after aging.

Examples 22 and 23 show that carbodiimide based heat stabilizers work very well with succinic acid based polyester polyol.

It is known that the carboxylic group (—COOH) can react with carbodiimide. One natural thought would be that the —COOH group in the polyester polyol polyols could react with carbodiimide and lead to stabilization of the molten hot melt adhesive. Following that thought we attempted heat stabilization using other chemicals which are known to react with —COOH such as aziridines, isocyanates and epoxy resins. Clearly isocyanate does not work as the system already contains unreacted isocyanate groups. Examples 21 and 24 show that aziridines do not work and in fact prematurely gel the system. Examples 25 to 27 illustrate epoxies do not work and in fact prematurely gel the system.

It was not possible to pretreat filler by itself with heat stabilizer. The filler would clump and aggregate with unacceptable results.

One more surprising piece of information against the conventional thought expressed above is that the filler, Calwhite in this case, is CaCO₃ and according to the supplier, it does not contain any —COOH and —OH groups. The examples show that we can pretreat the filler in a specific mixture including PPG and/or acrylic polymer with heat stabilizer and achieve a stable system. These results clearly show that the stabilizing effect is not simply from a reaction of —COOH with carbodiimide. Surprisingly, there is no clear mechanism by which the heat stabilizer achieves its effect.

Additional Examples were prepared and tested to investigate different heat stabilizers.

### Example 38—Comparative

269.9 parts of polyether polyol, 190.0 parts of thermoplastic polymer A, 140.0 parts of polyester polyol A1 and 250.0 parts of filler A were introduced into a heatable stirred tank reactor with a vacuum connection and heated up to 121° C. to melt and dissolve the materials therein. Moisture was removed in vacuo over a period of 1.5 hours at 121° C. The reactor was then purged with nitrogen, 146.0 parts of 4,4′-diphenylmethane-diisocyanate (MDI) was added and the contents of the reactor were stirred for 15 minutes under nitrogen at 121° C., and then 3 hours in vacuo at 121° C. The reactor was purged with nitrogen, 1.1 parts of 2,2′-dimorpholinildiethylether (DMDEE) was added and stirred for 15 minutes under nitrogen. The reaction product was then transferred to a moisture proof container and sealed immediately. Initial viscosity was 13,230 cP. The sample gelled during aging.

### Example 39—Comparative

269.9 parts of polyether polyol, 140.0 parts of polyester polyol A1, 190.0 parts of thermoplastic polymer A, and 250.0 parts of filler A were introduced into a heatable stirred tank reactor with a vacuum connection and heated up to 121° C. to melt the materials, then 5.0 parts of heat stabilizer L (TMOF) was introduced into the tank reactor. After pretreatment for 1.0 hour under nitrogen at 121° C., moisture was then removed in vacuo over a period of 1.5 hours at 121° C. The reactor was then purged with nitrogen, 146.0 parts of 4,4′-diphenylmethane-diisocyanate (MDI) were added and the contents of the reactor were stirred for 15 minutes under nitrogen at 121° C., and then 3 hours in vacuo at 121° C. The reactor was purged with nitrogen, 1.1 parts of 2,2′-dimorpholinildiethylether (DMDEE) was added and stirred for 15 minutes under nitrogen. The reaction product was then transferred to a moisture proof container and sealed immediately. Initial viscosity was 13,630 cP. The sample gelled during aging.

### Example 40—Comparative

269.9 parts of polyether polyol, 190.0 parts of thermoplastic polymer A, and 250.0 parts of filler A were introduced into a heatable stirred tank reactor with a vacuum connection and heated up to 121° C. to melt, then 5.0 parts of heat stabilizer L (TMOF) was introduced into the tank reactor. After pretreatment for 1.0 hour under nitrogen at 121° C., 140.0 parts of polyester polyol A1 was introduced and mixed therein. Moisture was removed in vacuo over a period of 1.5 hours at 121° C. The reactor was then purged with nitrogen, 146.0 parts of 4,4′-diphenylmethane-diisocyanate (MDI) was added and the contents of the reactor were stirred for 15 minutes under nitrogen at 121° C., and then 3 hours in vacuo at 121° C. The reactor was purged with nitrogen, 1.1 parts of 2,2′-dimorpholinildiethylether (DMDEE) was added and stirred for 15 minutes under nitrogen. The reaction product was then transferred to a moisture proof container and sealed immediately. Initial viscosity was 12,080 cP. The sample gelled during aging.

### Example 41—Comparative

269.9 parts of polyether polyol, 190.0 parts of thermoplastic polymer A, and 250.0 parts of filler A were introduced into a heatable stirred tank reactor with a vacuum connection and heated up to 121° C. to melt, then 5.0 parts of heat stabilizer H (A-174) was introduced into the tank reactor. After pretreatment for 1.0 hour under nitrogen at 121° C., 140.0 parts of polyester polyol A1 was introduced and mixed therein. Moisture was then removed in vacuo over a period of 1.5 hours at 121° C. The reactor was then purged with nitrogen, 146.0 parts of 4,4′-diphenylmethane-diisocyanate (MDI) was added and the contents of the reactor were stirred for 15 minutes under nitrogen at 121° C., and then 3 hours in vacuo at 121° C. The reactor was purged with nitrogen, 1.1 parts of 2,2′-dimorpholinildiethylether (DMDEE) was added and stirred for 15 minutes under nitrogen. The reaction product was then transferred to a moisture proof container and sealed immediately. Initial viscosity was 15,630 cP. The sample gelled during aging.

### Example 42—Comparative

269.9 parts of polyether polyol, 190.0 parts of thermoplastic polymer A, and 250.0 parts of filler A were introduced into a heatable stirred tank reactor with a vacuum connection and heated up to 121° C. to melt, then 5.0 parts of heat stabilizer G (A-171) was introduced into the tank reactor. After pretreatment for 1.0 hour under nitrogen at 121° C., 140.0 parts of polyester polyol A1 was introduced and mixed therein. Moisture was then removed in vacuo over a period of 1.5 hours at 121° C. The reactor was then purged with nitrogen, 146.0 parts of 4,4′-diphenylmethane-diisocyanate (MDI) was added and the contents of the reactor were stirred for 15 minutes under nitrogen at 121° C., and then 3 hours in vacuo at 121° C. The reactor was purged with nitrogen, 1.1 parts of 2,2′-dimorpholinildiethylether (DMDEE) was added and stirred for 15 minutes under nitrogen. The reaction product was then transferred to a moisture proof container and sealed immediately. Initial viscosity was 15,930 cP. The sample gelled during aging.

### Example 43—Comparative

269.9 parts of polyether polyol, 190.0 parts of thermoplastic polymer A, and 250.0 parts of filler A were introduced into a heatable stirred tank reactor with a vacuum connection and heated up to 121° C. to melt, then 5.0 parts of heat stabilizer I (A-link 35) was introduced into the tank reactor. After pretreatment for 1.0 hour under nitrogen at 121° C., 140.0 parts of polyester polyol A1 was introduced and mixed therein. Moisture was then removed in vacuo over a period of 1.5 hours at 121° C. The reactor was then purged with nitrogen, 146.0 parts of 4,4′-diphenylmethane-diisocyanate (MDI) was added and the contents of the reactor were stirred for 15 minutes under nitrogen at 121° C., and then 3 hours in vacuo at 121° C. The reactor was purged with nitrogen, 1.1 parts of 2,2′-dimorpholinildiethylether (DMDEE) was added and stirred for 15 minutes under nitrogen. The reaction product was then transferred to a moisture proof container and sealed immediately. Initial viscosity was 13,830 cP. The sample gelled during aging.

### Example 44—Inventive

269.9 parts of polyether polyol, 190.0 parts of thermoplastic polymer A, and 250.0 parts of filler A were introduced into a heatable stirred tank reactor with a vacuum connection and heated up to 121° C. to melt, then 5.0 parts of heat stabilizer E (STABAXOL P-200) was introduced into the tank reactor. After pretreatment for 1.0 hour under nitrogen at 121° C., 140.0 parts of polyester polyol A1 was introduced and mixed therein. Moisture was removed in vacuo over a period of 1.5 hours at 121° C. The reactor was then purged with nitrogen, 146.0 parts of 4,4′-diphenylmethane-diisocyanate (MDI) was added and the contents of the reactor were stirred for 15 minutes under nitrogen at 121° C., and then 3 hours in vacuo at 121° C. The reactor was purged with nitrogen, 1.1 parts of 2,2′-dimorpholinildiethylether (DMDEE) was added and stirred for 15 minutes under nitrogen. The reaction product was then transferred to a moisture proof container and sealed immediately. Initial viscosity was 11,550 cP. Aged viscosity was 41,500 cP.

### Example 45—Inventive

269.9 parts of polyether polyol, 190.0 parts of thermoplastic polymer A, and 250.0 parts of filler A were introduced into a heatable stirred tank reactor with a vacuum connection and heated to 121° C. to melt, then 5.0 parts of heat stabilizer F (DCC) was introduced into the tank reactor. After pretreatment for 1.0 hour under nitrogen at 121° C., 140.0 parts of polyester polyol A1 was introduced and mixed therein. Moisture was then removed in vacuo over a period of 1.5 hours at 121° C. The reactor was then purged with nitrogen, 146.0 parts of 4,4′-diphenylmethane-diisocyanate (MDI) was added and the contents of the reactor were stirred for 15 minutes under nitrogen at 121° C., and then 3 hours in vacuo at 121° C. The reactor was purged with nitrogen, 1.1 parts of 2,2′-dimorpholinildiethylether (DMDEE) was added and stirred for 15 minutes under nitrogen. The reaction product was then transferred to a moisture proof container and sealed immediately. Initial viscosity was 12,550 cP. Aged viscosity was 45,000 cP.

### Example 46—Comparative

269.9 parts of polyether polyol, 140.0 parts of polyester polyol A1, 190.0 parts of thermoplastic polymer A, and 250.0 parts of filler A were introduced into a heatable stirred tank reactor with a vacuum connection and heated up to 121° C. to melt. Then, moisture was removed in vacuo over a period of 1.5 hours at 121° C. The reactor was then purged with nitrogen, 5.0 parts of heat stabilizer E (STABAXOL P-200) was introduced into the tank reactor and pretreatment continued for 1.0 hour under nitrogen at 121° C. 146.0 parts of 4,4′-diphenylmethane-diisocyanate (MDI) was added and the contents of the reactor were stirred for 15 minutes under nitrogen at 121° C., and then 3 hours in vacuo at 121° C. The reactor was purged with nitrogen, 1.1 parts of 2,2′-dimorpholinildiethylether (DMDEE) was added and stirred for 15 minutes under nitrogen. The reaction product was then transferred to a moisture proof container and sealed immediately. Initial viscosity was 10,880 cP. Aged viscosity was 103,500 cP.

### Example 47—Inventive

269.9 parts of polyether polyol, 190.0 parts of thermoplastic polymer A, and 250.0 parts of filler A were introduced into a heatable stirred tank reactor with a vacuum connection and heated to 121° C. to melt, then 5.0 parts of heat stabilizer J (PTSI) was introduced into the tank reactor. After pretreatment for 1.0 hour under nitrogen at 121° C., 140.0 parts of polyester polyol A3 was introduced and mixed therein. Moisture was then removed in vacuo over a period of 1.5 hours at 121° C. The reactor was then purged with nitrogen, 146.0 parts of 4,4′-diphenylmethane-diisocyanate (MDI) was added and the contents of the reactor were stirred for 15 minutes under nitrogen at 121° C., and then 3 hours in vacuo at 121° C. The reactor was purged with nitrogen, 1.1 parts of 2,2′-dimorpholinildiethylether (DMDEE) was added and stirred for 15 minutes under nitrogen. The reaction product was then transferred to a moisture proof container and sealed immediately. Initial viscosity was 8,200 cP. Aged viscosity was 15,250 cP.

### Example 48—Comparative

140.0 parts of polyester polyol A3 was introduced into a heatable stirred tank reactor with a vacuum connection and heated up to 121° C. to melt, then 5.0 parts of heat stabilizer J (PTSI) was introduced into the tank reactor. After pretreatment for 1.0 hour under nitrogen at 121° C., 269.9 parts of polyether polyol, 190.0 parts of thermoplastic polymer A, and 250.0 parts of filler A were introduced and mixed therein. Moisture was then removed in vacuo over a period of 1.5 hours at 121° C. The reactor was then purged with nitrogen, 146.0 parts of 4,4′-diphenylmethane-diisocyanate (MDI) was added and the contents of the reactor were stirred for 15 minutes under nitrogen at 121° C., and then 3 hours in vacuo at 121° C. The reactor was purged with nitrogen, 1.1 parts of 2,2′-dimorpholinildiethylether (DMDEE) was added and stirred for 15 minutes under nitrogen. The reaction product was then transferred to a moisture proof container and sealed immediately. Initial viscosity was 7,075 cP. The sample separated during aging.

### Example 49—Comparative

269.9 parts of polyether polyol, 140.0 parts of polyester polyol A3, 190.0 parts of thermoplastic polymer A, and 250.0 parts of filler A were introduced into a heatable stirred tank reactor with a vacuum connection and heated to 121° C. to melt, then 5.0 parts of heat stabilizer J (PTSI) was introduced into the tank reactor. After pretreatment for 1.0 hour under nitrogen at 121° C., moisture was then removed in vacuo over a period of 1.5 hours at 121° C. The reactor was then purged with nitrogen, 146.0 parts of 4,4′-diphenylmethane-diisocyanate (MDI) was added and the contents of the reactor were stirred for 15 minutes under nitrogen at 121° C., and then 3 hours in vacuo at 121° C. The reactor was purged with nitrogen, 1.1 parts of 2,2′-dimorpholinildiethylether (DMDEE) was added and stirred for 15 minutes under nitrogen. The reaction product was then transferred to a moisture proof container and sealed immediately. Initial viscosity was 7,100 cP. The sample separated during aging.

### Example 50—Inventive

269.9 parts of polyether polyol, 190.0 parts of thermoplastic polymer A, and 250.0 parts of filler A were introduced into a heatable stirred tank reactor with a vacuum connection and heated up to 121° C. to melt, then 5.0 parts of heat stabilizer K (CSI) was introduced into the tank reactor. After pretreatment for 1.0 hour under nitrogen at 121° C., 140.0 parts of polyester polyol A1 was introduced and mixed therein. Moisture was then removed in vacuo over a period of 1.5 hours at 121° C. The reactor was then purged with nitrogen, 146.0 parts of 4,4′-diphenylmethane-diisocyanate (MDI) was added and the contents of the reactor were stirred for 15 minutes under nitrogen at 121° C., and then 3 hours in vacuo at 121° C. The reactor was purged with nitrogen, 1.1 parts of 2,2′-dimorpholinildiethylether (DMDEE) was added and stirred for 15 minutes under nitrogen. The reaction product was then transferred to a moisture proof container and sealed immediately. Initial viscosity was 9,450 cP. Aged viscosity was 17,500 cP.

### Example 51—Comparative

140.0 parts of polyester polyol A1 was introduced into a heatable stirred tank reactor with a vacuum connection and heated to 121° C. to melt, then 5.0 parts of heat stabilizer K (CSI) was introduced into the tank reactor. After pretreatment for 1.0 hour under nitrogen at 121° C., 269.9 parts of polyether polyol, 190.0 parts of thermoplastic polymer A, and 250.0 parts of filler A were introduced and dissolved therein. Moisture was then removed in vacuo over a period of 1.5 hours at 121° C. The reactor was then purged with nitrogen, 146.0 parts of 4,4′-diphenylmethane-diisocyanate (MDI) was added and the contents of the reactor were stirred for 15 minutes under nitrogen at 121° C., and then 3 hours in vacuo at 121° C. The reactor was purged with nitrogen, 1.1 parts of 2,2′-dimorpholinildiethylether (DMDEE) was added and stirred for 15 minutes under nitrogen. The reaction product was then transferred to a moisture proof container and sealed immediately. Initial viscosity was 10,750 cP. The sample separated during aging.

### Example 52—Comparative

269.9 parts of polyether polyol, 140.0 parts of polyester polyol A3, 190.0 parts of thermoplastic polymer A, and 250.0 parts of filler A were introduced into a heatable stirred tank reactor with a vacuum connection and heated to 121° C. to melt, then 5.0 parts of heat stabilizer K (CSI) was introduced into the tank reactor. After pretreatment for 1.0 hour under nitrogen at 121° C., moisture was then removed in vacuo over a period of 1.5 hours at 121° C. The reactor was then purged with nitrogen, 146.0 parts of 4,4′-diphenylmethane-diisocyanate (MDI) was added and the contents of the reactor were stirred for 15 minutes under nitrogen at 121° C., and then 3 hours in vacuo at 121° C. The reactor was purged with nitrogen, 1.1 parts of 2,2′-dimorpholinildiethylether (DMDEE) was added and stirred for 15 minutes under nitrogen. The reaction product was then transferred to a moisture proof container and sealed immediately. Initial viscosity was 11,500 cP. Aged viscosity was 62,000 cP.

### Example 53—Comparative

269.9 parts of polyether polyol, 190.0 parts of thermoplastic polymer A, and 250.0 parts of filler A were introduced into a heatable stirred tank reactor with a vacuum connection and heated up to 121° C. to melt, then 5.0 parts of heat stabilizer M (Incozol 2) was introduced into the tank reactor. After pretreatment for 1.0 hour under nitrogen at 121° C., 140.0 parts of polyester polyol A1 was introduced and mixed therein. Moisture was then removed in vacuo over a period of 1.5 hours at 121° C. The reactor was then purged with nitrogen, 146.0 parts of 4,4′-diphenylmethane-diisocyanate (MDI) were added and the contents of the reactor were stirred for 15 minutes under nitrogen at 121° C., and then 3 hours in vacuo at 121° C. The reactor was purged with nitrogen, 1.1 parts of 2,2′-dimorpholinildiethylether (DMDEE) was added and stirred for 15 minutes under nitrogen. The reaction product was then transferred to a moisture proof container and sealed immediately. Initial viscosity was 14,330 cP. The sample gelled during aging.

### Example 54—Comparative

140.0 parts of polyester polyol A1 was introduced into a heatable stirred tank reactor with a vacuum connection and heated to 121° C. to melt, then 5.0 parts of heat stabilizer M (Incozol 2) was introduced into the tank reactor. After pretreatment for 1.0 hour under nitrogen at 121° C., 269.9 parts of polyether polyol, 190.0 parts of thermoplastic polymer A, and 250.0 parts of filler A were introduced and mixed therein. Moisture was then removed in vacuo over a period of 1.5 hours at 121° C. The reactor was then purged with nitrogen, 146.0 parts of 4,4′-diphenylmethane-diisocyanate (MDI) was added and the contents of the reactor were stirred for 15 minutes under nitrogen at 121° C., and then 3 hours in vacuo at 121° C. The reactor was purged with nitrogen, 1.1 parts of 2,2′-dimorpholinildiethylether (DMDEE) was added and stirred for 15 minutes under nitrogen. The reaction product was then transferred to a moisture proof container and sealed immediately. Initial viscosity was 12,800 cP. The sample gelled during aging.

### Example 55—Comparative

269.9 parts of polyether polyol, 190.0 parts of thermoplastic polymer A, and 250.0 parts of filler A were introduced into a heatable stirred tank reactor with a vacuum connection and heated to 121° C. to melt, then 5.0 parts of MDI was introduced into the tank reactor. After pretreatment for 1.0 hour under nitrogen at 121° C., 140.0 parts of polyester polyol A1 was introduced and mixed therein. Moisture was then removed in vacuo over a period of 1.5 hours at 121° C. The reactor was then purged with nitrogen, 146.0 parts of 4,4′-diphenylmethane-diisocyanate (MDI) was added and the contents of the reactor were stirred for 15 minutes under nitrogen at 121° C., and then 3 hours in vacuo at 121° C. The reactor was purged with nitrogen, 1.1 parts of 2,2′-dimorpholinildiethylether (DMDEE) was added and stirred for 15 minutes under nitrogen. The reaction product was then transferred to a moisture proof container and sealed immediately. Initial viscosity was 29,380 cP. The sample gelled during aging.

### Example 56—Comparative

269.9 parts of polyether polyol, 140.0 parts of polyester polyol A1, 190.0 parts of thermoplastic polymer D, and 250.0 parts of filler A were introduced into a heatable stirred tank reactor with a vacuum connection and heated up to 121° C. to melt. Then, moisture was removed in vacuo over a period of 1.5 hours at 121° C. The reactor was then purged with nitrogen, 146.0 parts of 4,4′-diphenylmethane-diisocyanate (MDI) was added and the contents of the reactor were stirred for 15 minutes under nitrogen at 121° C., and then 3 hours in vacuo at 121° C. The reactor was purged with nitrogen, 1.1 parts of 2,2′-dimorpholinildiethylether (DMDEE) was added and stirred for 15 minutes under nitrogen. The reaction product was then transferred to a moisture proof container and sealed immediately. Initial viscosity was 14,100 cP. The sample separated and gelled during aging.

### Example 57—Comparative

269.9 parts of polyether polyol, 140.0 parts of polyester polyol A1, and 190.0 parts of thermoplastic polymer A were introduced into a heatable stirred tank reactor with a vacuum connection and heated up to 121° C. to melt. Then, moisture was removed in vacuo over a period of 1.5 hours at 121° C. The reactor was then purged with nitrogen, and 250.0 parts of filler A was added and continued to dry in vacuo over a period of 1.0 hour at 121° C. Then, 146.0 parts of 4,4′-diphenylmethane-diisocyanate (MDI) was added and the contents of the reactor were stirred for 15 minutes under nitrogen at 121° C., and then 3 hours in vacuo at 121° C. The reactor was purged with nitrogen, 1.1 parts of 2,2′-dimorpholinildiethylether (DMDEE) was added and stirred for 15 minutes under nitrogen. The reaction product was then transferred to a moisture proof container and sealed immediately. Initial viscosity was 12,500 cP. The sample gelled during aging.

### Example 58—Comparative

269.9 parts of polyether polyol, 190.0 parts of thermoplastic polymer A, and 250.0 parts of filler A were introduced into a heatable stirred tank reactor with a vacuum connection and heated up to 121° C. to melt, then 5.0 parts of heat stabilizer C (Aziridine PZ33) was introduced into the tank reactor under nitrogen at 121° C. The blend gelled while mixing.

### Example 59—Comparative

140.0 parts of polyester polyol A1 was introduced into a heatable stirred tank reactor with a vacuum connection and heated to 121° C. to melt, then 0.6 parts of heat stabilizer D (DER331) and 4.4 parts of heat stabilizer G (Silquest A-171) were introduced into the tank reactor. After pretreatment for 1.0 hour under nitrogen at 121° C., 269.9 parts of polyether polyol, 190.0 parts of thermoplastic polymer A, and 250.0 parts of filler A were introduced and mixed therein. Moisture was then removed in vacuo over a period of 1.5 hours at 121° C. The reactor was then purged with nitrogen, 146.0 parts of 4,4′-diphenylmethane-diisocyanate (MDI) was added and the contents of the reactor were stirred for 15 minutes under nitrogen at 121° C., and then 3 hours in vacuo at 121° C. The reactor was purged with nitrogen, 1.1 parts of 2,2′-dimorpholinildiethylether (DMDEE) was added and stirred for 15 minutes under nitrogen. The reaction product was then transferred to a moisture proof container and sealed immediately. Initial viscosity was 15,850 cP. The sample gelled during aging.

### Example 60—Comparative

269.9 parts of polyether polyol, 190.0 parts of thermoplastic polymer A, and 250.0 parts of filler A were introduced into a heatable stirred tank reactor with a vacuum connection and heated up to 121° C. to melt, then 0.6 parts of heat stabilizer D (DER331) and 4.4 parts of heat stabilizer G (Silquest A-171) were introduced into the tank reactor. After pretreatment for 1.0 hour under nitrogen at 121° C., 140.0 parts of polyester polyol A1 was introduced and mixed therein. Moisture was then removed in vacuo over a period of 1.5 hours at 121° C. The reactor was then purged with nitrogen, 146.0 parts of 4,4′-diphenylmethane-diisocyanate (MDI) was added and the contents of the reactor were stirred for 15 minutes under nitrogen at 121° C., and then 3 hours in vacuo at 121° C. The reactor was purged with nitrogen, 1.1 parts of 2,2′-dimorpholinildiethylether (DMDEE) was added and stirred for 15 minutes under nitrogen. The reaction product was then transferred to a moisture proof container and sealed immediately. Initial viscosity was 16,330 cP. The sample gelled during aging.

### Example 61—Comparative

140.0 parts of polyester polyol A1 was introduced into a heatable stirred tank reactor with a vacuum connection and heated to 121° C. to melt, then 0.6 parts of heat stabilizer D (DER331) was introduced into the tank reactor. After pretreatment for 1.0 hour under nitrogen at 121° C., 4.4 parts of heat stabilizer M (Incozol 2) was introduced into the tank reactor and pretreatment continued for 45 min under nitrogen at 121° C., then 269.9 parts of polyether polyol, 190.0 parts of thermoplastic polymer A, and 250.0 parts of filler A were introduced and mixed therein. Moisture was then removed in vacuo over a period of 1.5 hours at 121° C. The reactor was then purged with nitrogen, 146.0 parts of 4,4′-diphenylmethane-diisocyanate (MDI) was added and the contents of the reactor were stirred for 15 minutes under nitrogen at 121° C., and then 3 hours in vacuo at 121° C. The reactor was purged with nitrogen, 1.1 parts of 2,2′-dimorpholinildiethylether (DMDEE) was added and stirred for 15 minutes under nitrogen. The reaction product was then transferred to a moisture proof container and sealed immediately. Initial viscosity was 9,000 cP. Aged viscosity was 116,000 and the sample had minor separation during aging.

### Example 62—Comparative

269.9 parts of polyether polyol, 190.0 parts of thermoplastic polymer A, and 250.0 parts of filler A were introduced into a heatable stirred tank reactor with a vacuum connection and heated to 121° C. to melt, then 1.25 parts of heat stabilizer C (Aziridine PZ33) and 3.75 parts of heat stabilizer G (Silquest A-171) were introduced into the tank reactor. After pretreatment for 1.0 hour under nitrogen at 121° C., 140.0 parts of polyester polyol A1 were introduced and dissolved therein. Moisture was then removed in vacuo at 121° C. The blend gelled during the moisture removal process.

### Example 63—Comparative

269.9 parts of a polyether polyol, 190.0 parts of thermoplastic polymer A, and 250.0 parts of filler A were introduced into a heatable stirred tank reactor with a vacuum connection and heated up to 121° C. to melt, then 1.25 parts of heat stabilizer C and 3.75 parts of heat stabilizer M were introduced into the tank reactor. After pre-treated for 1.0 hour under nitrogen at 121° C., 140.0 parts of polyester polyol A1 were introduced and dissolved therein. Moisture was then removed in vacuo at 121° C. The blend gelled during the moisture removal process.

### Example 64—Comparative

269.9 parts of a polyether polyol, 190.0 parts of thermoplastic polymer A, 140.0 parts of polyester polyol A1, and 250.0 parts of filler A were introduced into a heatable stirred tank reactor with a vacuum connection and heated up to 121° C. to melt and dissolve therein. Moisture was then removed in vacuo over a period of 1.5 hours at 121° C. The reactor was then purged with nitrogen, 146.0 parts of 4,4′-diphenylmethane-diisocyanate (MDI) were added and the contents of the reactor were stirred for 15 minutes under nitrogen at 121° C., and then 3 hours in vacuo at 121° C. The reactor was purged with nitrogen, 5.0 parts of heat stabilizer A and 1.1 parts of catalyst were added and stirred for 15 minutes under nitrogen. The reaction product was then transferred to a moisture proof container and immediately sealed without moisture. Initial viscosity was 65,900 cP. Final viscosity was not taken as material gelled during aging.

The following Table lists compositions and results for the above examples.

| | | | | | | | | 2nd mix | | | |
|---|---|---|---|---|---|---|---|---|---|---|---|
| | | 1st mix | | | | | | PeP | | | |
| | | | | PeP | | | ht | or | | | result |
| Ex. | type | PPG | PeP | acid # | TP | filler | stab | PPG | TP | filler | % |
| 38 | C | PPG | A1 | 1.44 | A | A | none | none | none | none | g-a |
| 39 | C | PPG | A1 | 1.44 | A | A | L | none | none | none | g-a |
| 40 | C | PPG | none | | A | A | L | A1 | none | none | g-a |
| 41 | C | PPG | none | | A | A | H | A1 | none | none | g-a |
| 42 | C | PPG | none | | A | A | G | A1 | none | none | g-a |
| 43 | C | PPG | none | | A | A | I | A1 | none | none | g-a |
| 44 | I | PPG | none | | A | A | E | A1 | none | none | 259 |
| 45 | I | PPG | none | | A | A | F | A1 | none | none | 259 |
| 46 | C | PPG | A1 | 1.44 | A | A | E | none | none | none | 851 |
| 47 | I | PPG | none | | A | A | J | A3 | none | none | 86 |
| 48 | C | none | A3 | 1.28 | none | none | J | PPG | A | A | s-a |
| 49 | C | PPG | A3 | 1.28 | A | A | J | none | none | none | s-a |
| 50 | I | PPG | none | | A | A | K | A1 | none | none | 85 |
| 51 | C | none | A1 | 1.44 | none | none | K | PPG | A | A | s-a |
| 52 | C | PPG | A3 | 1.28 | A | A | K | none | none | none | 439 |
| 53 | C | PPG | | | A | A | M | A1 | none | none | g-a |
| 54 | C | none | A1 | 1.44 | none | none | M | PPG | A | A | g-a |
| 55 | C | PPG | none | | A | A | none | A1 | none | none | g-a |
| 56 | C | PPG | A1 | 1.44 | D | A | none | none | none | none | s-a/g- |
| | | | | | | | | | | | a |
| 57 | C | PPG | A1 | 1.44 | A | A | none | none | none | none | g-a |
| 58 | C | PPG | none | | A | A | C | none | none | none | gelled |
| 59 | C | none | A1 | 1.44 | none | none | D + G | PPG | A | A | g-a |
| 60 | C | PPG | none | | A | A | D + G | A1 | none | none | g-a |
| 61 | C | none | A1 | 1.44 | none | none | D + M | PPG | A | A | 1189 |
| 62 | C | PPG | none | | A | A | C + G | A1 | none | none | gelled |
| 63 | C | PPG | none | | A | A | C + M | A1 | none | none | gelled |
| 64 | C | PPG | A1 | 1.44 | A | A | A | none | none | none | g-a |

type C is comparative, type I is inventive
PPG is polyether polyol; PeP is polyester polyol; TP is thermoplastic polymer; ht stab is heat stabilizer candidate.
result is % viscosity increase after aging; g-a gel during aging; g-r gel during reaction; s-a separate during aging

Example 38 again shows that adding filler and polyester polyols to a reactive polyurethane hot melt adhesive composition can significantly degrade the heat stability of that hot melt composition. In the worst case situation a composition will gel during reaction.

Example 56 uses Dianal BR-107 with an acid number of 0. Example 56 was just as unstable as samples made using thermoplastic polymers with acid numbers of 3.5 and 5. This appears to show that the acid group from a thermoplastic resin, in this case acrylic polymer, is not the reason for reactive polyurethane hot melt adhesive composition heat instability.

Example 57 shows that rigorous attempts to remove traces of moisture from the polyester polyol and/or the inorganic filler, even individually, does not make the filled polyurethane reactive hot melt adhesive composition more stable. This may indicate that moisture is not the cause of filled polyurethane reactive hot melt adhesive composition heat instability or that intensive physical drying at elevated temperature is not sufficient to remove moisture.

Examples 39-43, 53-55 show that TMOF, silanes, isocyanatosilane, oxazolidine, and diisocyanate cannot be used to stabilize filled polyurethane reactive hot melt systems. Examples 21 and 24 show that aziridines do not work and in fact prematurely gel the system. Examples 25 to 27 illustrate epoxies do not work and in fact prematurely gel the system. This is true even when these candidates were used to pretreat either polyester polyol or the inorganic filler in the composition.

Example 59 and Example 60, each using a combination of a silane stabilizer as a moisture scavenger and epoxy resin stabilizer as an acid scavenger, were not useful as heat stabilizers for a filled, polyurethane reactive hot melt adhesive composition. This was true even though the filler and polyester polyol were separately treated before reaction.

Example 61 using a physical blend of an oxazolidine moisture scavenger and an epoxy resin acid scavenger, was not useful as a heat stabilizer for a filled, polyurethane reactive hot melt adhesive composition. This was true even though the polyester polyol was separately treated before reaction.

Example 62 shows using a physical blend of an aziridine acid scavenger and a silane moisture scavenger was not useful as a heat stabilizer for a filled polyurethane reactive hot melt composition. This was true even though the filler was separately treated before reaction.

Example 63 shows using a physical blend of an aziridine acid scavenger and Incozol 2, an oxazolidine moisture scavenger was not useful as a heat stabilizer for a filled polyurethane reactive hot melt composition. This was true even though the filler was separately treated before reaction.

Examples 44-52 show that monomeric carbodiimides, polymeric carbodiimides and sulfonyl isocyanates can stabilize filled, polyurethane reactive hot melt adhesive compositions as long as either polyester polyol or the inorganic filler is pretreated using the stabilizer before mixing of the polyester polyol and the inorganic filler together for production of final product. Examples 48 and 51 illustrate that sulfonyl isocyanate can react very quickly with the primary hydroxyl group of the polyester polyol. When using sulfonyl isocyanates this effect should be take into account in dosing or choosing to pretreat the inorganic filler.

Multiple Examples show that carbodiimide compounds are effective heat stabilizers when used to pretreat either the polyester polyol or the inorganic filler of a hot melt adhesive composition prior to reaction into a prepolymer. Example 64 illustrates the surprising result that adding the same amount of the same carbodiimide compound separately to an already reacted hot melt adhesive composition made using the same components (e.g. not pretreating either the polyester polyol or the inorganic filler) does not provide any heat stabilizing effect.

A moisture scavenger can be defined as a compound which reacts with water in a composition at ambient temperature or elevated temperature such as 121° C. to eliminate water from the composition so that water cannot interact with other components in the composition to generate an undesirable effect. An acid scavenger can be defined as a compound which reacts with acidic moieties such as carboxylic acid moieties in a composition at ambient temperature or high temperature such as 121° C. to eliminate acid from the composition so that acid cannot interact with other components in the composition to generate an undesirable effect. Without wishing to be limited to any theory, one common feature of both carbodiimide and sulfonyl isocyanate is that they both are a moisture scavenger and also an acid scavenger. TMOF, silanes, isocyanatosilane, oxazolidine, and diisocyanate can be considered to be only moisture scavengers and epoxy and aziridine can be considered to be only acid scavengers. A common feature for all of the ineffective heat stabilizer candidates is they can be either a moisture scavenger or an acid scavenger, but not both. Surprisingly, the mixtures of a moisture scavenger compound and an acid scavenger compound that were tested did not provide any benefit.

The Examples show that there are a limited number of chemical compounds that can stabilize filled, polyurethane reactive hot melt adhesive compositions. Further, there is no apparent mechanism to help select compounds useful for this application.

The Examples also show that preparation of the disclosed hot melt adhesives must be particularly sequenced to obtain the beneficial heat stability. Simply adding all of the components in a single mixture makes the resulting hot melt adhesive less stable and may lead to gelling during reaction and before any use. Adding heat stabilizer to a mixture of polyester polyol and filler makes the resulting hot melt adhesive less stable and may lead to gelling during reaction and before any use. Adding heat stabilizer to an already formed hot melt adhesive composition is also not effective. To obtain improved heat stability the heat stabilizer must be added to either the polyester polyol without any filler or to the filler without any polyester polyol. The polyester polyol or filler comprises a mixture to which the heat stabilizer is added, however that mixture cannot contain the other component. Preferably the filler mixture comprises polyether polyol and/or acrylic thermoplastic polymer. Once the heat stabilizer has been added and mixed for a sufficient time of greater that 35 minutes, preferably greater than 45 minutes and typically about one hour, the remaining polyols, thermoplastic polymer and filler can be added to the reactor, placed under heat and vacuum to remove moisture and mixed. Polyisocyanate can be added to the dried mixture in the reactor which is maintained under heat and an inert gas barrier to exclude moisture. After the isocyanate reaction is complete catalyst can optionally be mixed in. The final product will be moisture reactive and can be transferred to a moisture proof container and sealed immediately to exclude atmospheric moisture. Additives, if used, can be added at appropriate times before, during or after reaction.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

We claim:

1. A moisture reactive hot melt adhesive polyurethane composition that is the reaction product of:
a first mixture comprising a heat stabilizer and only one of a polyester polyol or a filler, wherein the first mixture can optionally comprise a polyether polyol and/or a thermoplastic polymer but does not comprise all of the heat stabilizer and the polyester polyol and the filler;
a second mixture comprising the other of the polyester polyol or the filler not present in the first mixture; wherein the second mixture can optionally comprise the polyether polyol and/or the thermoplastic polymer; and
a polyisocyanate.

2. The moisture reactive hot melt adhesive polyurethane composition of claim 1, wherein the second mixture is mixed with the first mixture and the polyisocyanate is reacted with the combined first mixture and second mixture.

3. The moisture reactive hot melt adhesive polyurethane composition of claim 1, wherein the first mixture has been mixed for at least 35 minutes; before mixing with the second mixture or polyisocyanate.

4. The moisture reactive hot melt adhesive polyurethane composition of claim 1, wherein the polyester polyol is the reaction product of a diol having 2 to 8 carbon atoms and a diacid having 2 to 8 carbon atoms.

5. The moisture reactive hot melt adhesive polyurethane composition of claim 1, wherein the polyester polyol has a structure of Formula 1 or of Formula 2; wherein Formula 1 is:
H—[O(CH₂)ₘOOC(CH₂)ₙCO]ₖ—O(CH₂)ₚ—OH;
m and n being an independently selected even integer; m+n=6 to 10; m and n are independently selected from 2, 4, 6 or 8; p is equal to m; k is an integer from 9 to 55; and
the polyol of Formula I has a number average molecular weight of around 2,000 to 11.000; and
Formula 2 is:
HO—[(CH₂)₅COO]ₚ—R₁—[OOC(CH₂)₅]_{q}—OH;
R₁ is an initiator; p is an integer from 0 to 96; q is an integer from 0 to 96; p+q=16 to 96; and the polyol has a number average molecular weight of about 2,000 to about 11,000.

6. The moisture reactive hot melt adhesive polyurethane composition of claim 1, wherein the first mixture and/or the second mixture comprise one or more of MA-SCA acid, catalyst, organosilane and additive.

7. The moisture reactive hot melt adhesive polyurethane composition of claim 1, wherein the filler is CaCO₃ and/or comprising about 10 to about 50 wt. % filler, based on the total adhesive weight.

8. The moisture reactive hot melt adhesive polyurethane composition of claim 1, wherein the thermoplastic polymer is an acrylic polymer.

9. The moisture reactive hot melt adhesive polyurethane composition of claim 1, wherein the thermoplastic polymer is an acrylic polymer and the first mixture comprises the filler and the acrylic polymer.

10. The moisture reactive hot melt adhesive polyurethane composition of claim 1, wherein the first mixture, the second mixture or both the first mixture and the second mixture comprise the polyether polyol and the polyether polyol is polypropylene glycol.

11. The moisture reactive hot melt adhesive polyurethane composition of claim 1, comprising an isocyanate functional polyurethane prepolymer.

12. The moisture reactive hot melt adhesive polyurethane composition of claim 1, further comprising an additive selected from catalyst, additional filler, adhesion promoter, plasticizer, colorant, rheology modifier, flame retardant, UV pigment, nanofiber, defoamer, tackifier, anti-oxidant, additional stabilizer, thixotrope and mixtures thereof.

13. The moisture reactive hot melt adhesive polyurethane composition of claim 1, further comprising 2,2′-dimorpholinildiethylether (DMDEE).

14. The moisture reactive hot melt adhesive polyurethane composition of claim 1, wherein the heat stabilizer is a compound having both moisture scavenging functionality and acid scavenging functionality.

15. The moisture reactive hot melt adhesive polyurethane composition of claim 1, wherein the heat stabilizer is selected from carbodiimide; sulfonyl isocyanate and mixtures thereof.

16. An article of manufacture comprising the moisture reactive hot melt adhesive composition according to claim 1.

17. A method of bonding two substrates together comprising:
providing a first substrate and a second substrate
providing the hot melt adhesive according claim 1;
heating the hot melt adhesive according claim 1 to molten form;
applying the hot melt adhesive according claim 1 in molten form to the first substrate;
bringing the second substrate into contact with the adhesive applied on the first substrate; and
allowing the adhesive to cool and cure to an irreversible solid form.

18. Cured reaction products of the hot melt adhesive composition according to claim 1.

19. A method of making a moisture reactive hot melt adhesive having improved heat stability, comprising:
providing a first part comprising a heat stabilizer and only one of a polyester polyol or a filler, wherein the first part can optionally comprise a polyether polyol and/or a thermoplastic polymer but does not comprise all of the heat stabilizer and the polyester polyol and the filler;
mixing the first part for a time sufficient to pretreat the polyester polyol or the filler;
providing a second part comprising the other of polyester polyol or filler not present in the first part;
providing a polyisocyanate; and
reacting the first part, the polyisocyanate and the second part to form a moisture reactive, polyurethane hot melt adhesive.

20. The method of claim 19 wherein the second part is mixed with the first part to form a mixture and the polyisocyanate is reacted with the mixture.

21. The method of claim 19 wherein the polyisocyanate is reacted with the first part to form a mixture and the second part is reacted with the mixture.

22. The method of claim 19 wherein the polyisocyanate is reacted with the second part to form a mixture and the first part is reacted with the mixture.
